(19) United States
(12) Patent Application Publication
(10) Pub. No.: US 2025/0380052 A1
(43) Pub. Date: Dec. 11, 2025

(54) PROCESSING DEVICE

(71) Applicant: FUJIFILM Corporation, Tokyo (JP)

(72) Inventor: Kentaro MIYAMOTO, Saitama (JP)

(73) Assignee: FUJIFILM Corporation, Tokyo (JP)

(21) Appl. No.: 19/300,634

(22) Filed: Aug. 14, 2025

Related U.S. Application Data
(63) Continuation of application No. PCT/JP2024/002589, filed on Jan. 29, 2024.

(30) Foreign Application Priority Data
Feb. 20, 2023 (JP) 2023-024418

(51) Int. Cl. H04N 23/60; H04N 23/63; H04N 23/698

(52) U.S. Cl. CPC H04N 23/64; H04N 23/632; H04N 23/634; H04N 23/698

(57) ABSTRACT

There is provided a processing device that can easily check settings of each of a plurality of cameras in a case of performing imaging with each of the cameras. The processing device processes images captured by the plurality of cameras and includes a processor. The processor sets a plurality of independent image display regions corresponding to the plurality of cameras on a first screen and outputs the image display regions to a display destination. The processor displays the images of the plurality of cameras in the plurality of image display regions in a state where a first range in which images overlap each other between the images of the cameras adjacent to each other and a second range in which the images do not overlap each other are identifiable.

### CROSS-REFERENCE TO RELATED APPLICATIONS

The present application is a Continuation of PCT International Application No. PCT/JP2024/002589 filed on Jan. 29, 2024 claiming priority under 35 U.S.C § 119(a) to Japanese Patent Application No. 2023-024418 filed on Feb. 20, 2023. Each of the above applications is hereby expressly incorporated by reference, in its entirety, into the present application.

### BACKGROUND OF THE INVENTION

### 1. Field of the Invention

The present invention relates to a processing device and more particularly, to a processing device that processes images captured by a plurality of cameras.

### 2. Description of the Related Art

A technique of imaging a wall surface of a structure such as a tunnel with a camera, analyzing the obtained image, and detecting damage (cracking or the like) occurring on the wall surface of the structure is known.

JP2016-218555A, JP2016-57579A, JP2004-12152A, JP2001-141660A, and JP1997-161068A (JP-H9-161068A) describe a method of acquiring a high-resolution image by mounting a plurality of cameras on a vehicle, performing imaging with imaging regions overlapping each other between cameras adjacent to each other, and panoramically composing the obtained image.

In addition, JP2020-5186A describes a method of imaging a surface of a structure while deviating an imaging position manually or with a drone, or the like. In addition, JP2020-5186A describes that, in a case of displaying the captured image, the captured image is displayed with a region overlapping an image adjacent thereto deleted.

### SUMMARY OF THE INVENTION

One embodiment according to the technique of the present disclosure provides a processing device that can, in a case of imaging with a plurality of cameras, easily check settings of each of the cameras.

(1) A processing device that processes images captured by a plurality of cameras, the processing device comprising a processor, in which the processor is configured to set a plurality of independent image display regions corresponding to the plurality of cameras on a first screen that outputs to a display destination; and display, in the plurality of image display regions, images of the plurality of cameras in a state where a first range in which images overlap each other between images of the cameras adjacent to each other and a second range in which the images do not overlap each other are identifiable.

(2) The processing device of (1), in which the plurality of cameras include a pair of cameras having imaging regions overlapping each other.

(3) The processing device of (1) or (2), in which the processor is configured to set the plurality of image display regions in a layout corresponding to disposition of the plurality of cameras.

(4) The processing device of any one of (1) to (3), in which the processor is configured to detect the first range and/or the second range by processing the images of the plurality of cameras.

(5) The processing device of any one of (1) to (3), in which the processor is configured to acquire information related to a subject and information related to the plurality of cameras and detect the first range and/or the second range based on the acquired information.

(6) The processing device of any one of (1) to (5), in which the processor is configured to calculate an overlap ratio of the images displayed in the image display regions based on the first range and/or the second range and display the overlap ratio on the first screen.

(7) The processing device of (6), in which the processor is configured to determine appropriateness of settings of the plurality of cameras based on the overlap ratio and display a determination result on the first screen.

(8) The processing device of (6), in which the processor is configured to acquire correction conditions of settings of the plurality of cameras based on the overlap ratio and display the correction conditions on the first screen.

(9) The processing device of any one of (1) to (8), in which the processor is configured to display the images, which are captured by the plurality of cameras in chronological order, in the image display regions in chronological order.

(10) The processing device of any one of (1) to (9), in which the processor is configured to acquire information on the plurality of cameras and display the information on the plurality of cameras on a second screen different from the first screen.

(11) The processing device of (10), in which the processor is configured to acquire information related to a subject, estimate imaging parameters of the plurality of cameras, which are set in a case of imaging the subject, based on the acquired information, and set the imaging parameters of the plurality of cameras in accordance with an estimation result.

(12) The processing device of (10) or (11), in which the information on the cameras includes at least one type of information related to imaging parameters, information related to an available storage capacity, or information related to a battery.

(13) The processing device of any one of (10) to (12), in which the processor is configured to receive individually or collectively a change in the imaging parameters of the plurality of cameras on the second screen and change individually or collectively the imaging parameters of the cameras in accordance with received content.

(14) The processing device of any one of (10) to (13), in which the processor is configured to determine appropriateness of states of the plurality of cameras based on the information on the plurality of cameras and display a determination result on the second screen.

(15) The processing device of any one of (1) to (14), in which the processor is configured to display recorded images of the plurality of cameras on a third screen different from the first screen.

(16) The processing device of (15), in which the processor is configured to panoramically compose the recorded images of the plurality of cameras and display a panoramically composed image on the third screen.

(17) The processing device of (15) or (16), in which the processor is configured to determine appropriateness of imaging with respect to the recorded images of the plurality of cameras based on the images and/or information added to the images and display a determination result on the third screen.

(18) The processing apparatus of (17), in which the processor is configured to determine the appropriateness of the imaging based on a histogram of the images.

(19) The processing device of (17), in which the processor is configured to determine the appropriateness of the imaging based on information on imaging parameters added to the images.

(20) The processing device of any one of (15) to (19), in which the processor is configured to receive selection of an image on the third screen and display an imaging parameter of the selected image on the third screen.

(21) The processing device of (20), in which the processor is configured to display, on the third screen, the imaging parameter of the selected image and an imaging parameter of the camera in a case of imaging the selected image in a comparable state.

### BRIEF DESCRIPTION OF THE DRAWINGS

FIG. 1 is a view showing a schematic configuration of an imaging system.

FIG. 2 is a perspective view showing a configuration of a multi-eye imaging apparatus.

FIG. 3 is a front view showing the configuration of the multi-eye imaging apparatus.

FIG. 4 is a side view showing the configuration of the multi-eye imaging apparatus.

FIG. 5 is a front view showing attachment states of cameras and illumination devices to a front panel.

FIG. 6 is a rear view showing the attachment states of the cameras and the illumination devices to the front panel.

FIG. 7 is a front view showing attachment states of cameras and illumination devices to a rear panel.

FIG. 8 is a rear view showing the attachment states of the cameras and the illumination devices to the rear panel.

FIG. 9 is a block diagram showing an electric configuration of the multi-eye imaging apparatus.

FIG. 10 is a diagram showing an example of a hardware configuration of a control device.

FIG. 11 is a functional block diagram of an imaging control function of the control device.

FIG. 12 is a functional block diagram of a live view function of the control device.

FIG. 13 is a diagram showing an example of a live view display screen.

FIG. 14 is a conceptual diagram of displaying an image in an image display region.

FIG. 15 is a functional block diagram of functions of the control device in a case where an overlap range is acquired by calculation.

FIG. 16 is a diagram showing another example of the live view display screen.

FIG. 17 is a diagram showing still another example of the live view display screen.

FIG. 18 is a diagram showing still another example of the live view display screen.

FIG. 19 is a functional block diagram of the control device.

FIG. 20 is a diagram showing still another example of the live view display screen.

FIG. 21 is a functional block diagram of the control device.

FIG. 22 is a diagram showing an example of a camera information display screen.

FIG. 23 is a diagram showing an example of a method of receiving a setting change.

FIG. 24 is a functional block diagram of the control device.

FIG. 25 is a diagram showing an example of a camera recommended settings display screen.

FIG. 26 is a functional block diagram of the control device.

FIG. 27 is a diagram showing an example of a captured image display screen.

FIG. 28 is a diagram showing an example of a display screen of a panoramically composed image.

FIG. 29 is a diagram showing an example of display of imaging parameters.

FIG. 30 is a diagram showing another example of the display of the imaging parameters.

FIG. 31 is a functional block diagram of the control device.

FIG. 32 is a diagram showing another example of the captured image display screen.

### DESCRIPTION OF THE PREFERRED EMBODIMENTS

Hereinafter, description of preferred embodiments of the present invention will be made in detail with reference to the accompanying drawings.

### First Embodiment

Herein, a case where the present invention is applied to a system that images an inner wall surface of a tunnel structure will be described as an example.

A tunnel structure such as a water channel of a hydroelectric power generation facility and a subway tunnel is regularly inspected in order to ensure safety. Recently, there has been a shift from visual inspection to image inspection. The image inspection is performed by imaging a surface of the tunnel structure with a camera and detecting damage such as cracking from the obtained image through visual inspection or image processing.

Imaging is usually performed by using a dedicated imaging apparatus that can image the entire circumference of the tunnel. The imaging apparatus is configured with a plurality of cameras. The plurality of cameras are disposed in accordance with a cross-sectional shape of the tunnel structure, and imaging regions of cameras adjacent to each other are set to partially overlap each other.

However, there are various cross-sectional shapes of the tunnel structure. Therefore, it is necessary for the imaging apparatus to lay out the plurality of cameras and to set imaging conditions of individual cameras, in accordance with a target. In a case where this work is performed onsite, a large amount of work time is required. In addition, in a case where there is a setting mistake in even one camera, reimaging is necessary. Thus, it is necessary to guarantee that the setting can be performed under correct imaging conditions before imaging start.

As an imaging system of the present embodiment, there is provided a system in which imaging is performed by the plurality of cameras, which is an imaging system in which settings of each camera can be easily checked.

### Configuration of Imaging System

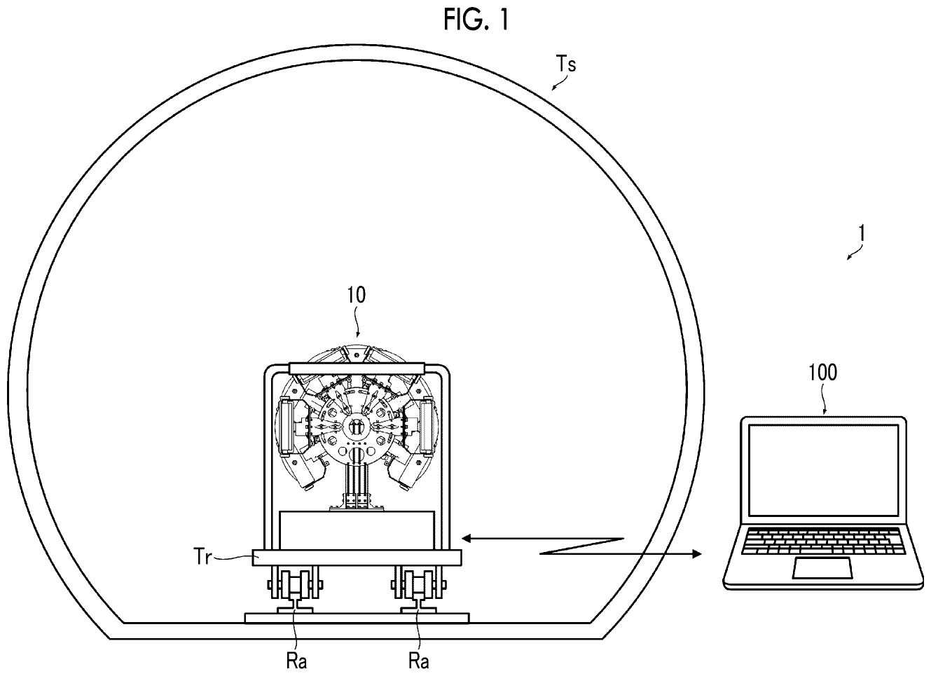

FIG. 1 is a view showing a schematic configuration of the imaging system.

As described above, an imaging system 1 of the present embodiment is configured as a system that images an inner wall surface of a tunnel structure TS. The tunnel structure TS which is an imaging target has an arc cross-sectional shape (semicircular shape).

As shown in FIG. 1, the imaging system 1 of the present embodiment comprises a multi-eye imaging apparatus 10 that images the inner wall surface of the tunnel structure TS using the plurality of cameras and a control device 100 that controls the multi-eye imaging apparatus 10 and that processes an image captured by the multi-eye imaging apparatus 10.

The multi-eye imaging apparatus 10 is mounted on, for example, a carriage Tr and performs imaging while moving in the tunnel structure TS. In a case where a rail Ra is laid in the tunnel structure TS, the carriage Tr travels on the rail Ra. The carriage Tr has an electric assist function as necessary.

### Multi-Eye Imaging Apparatus

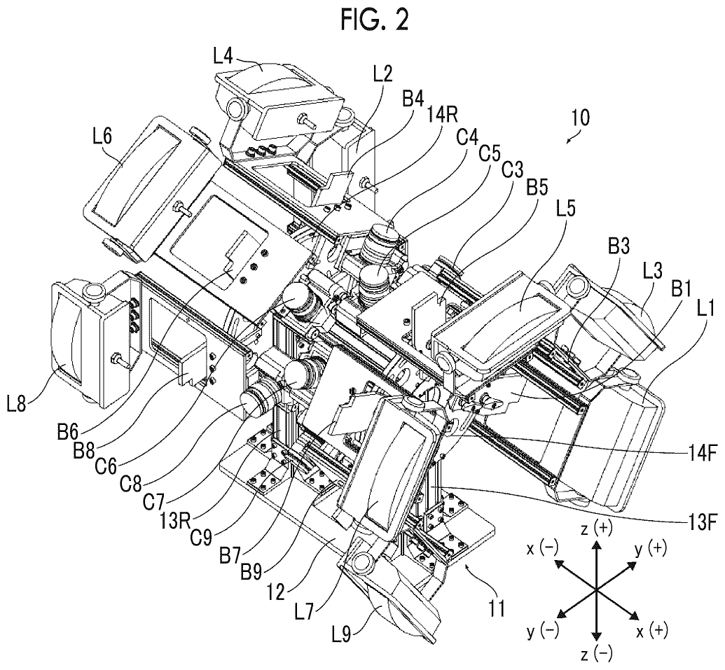

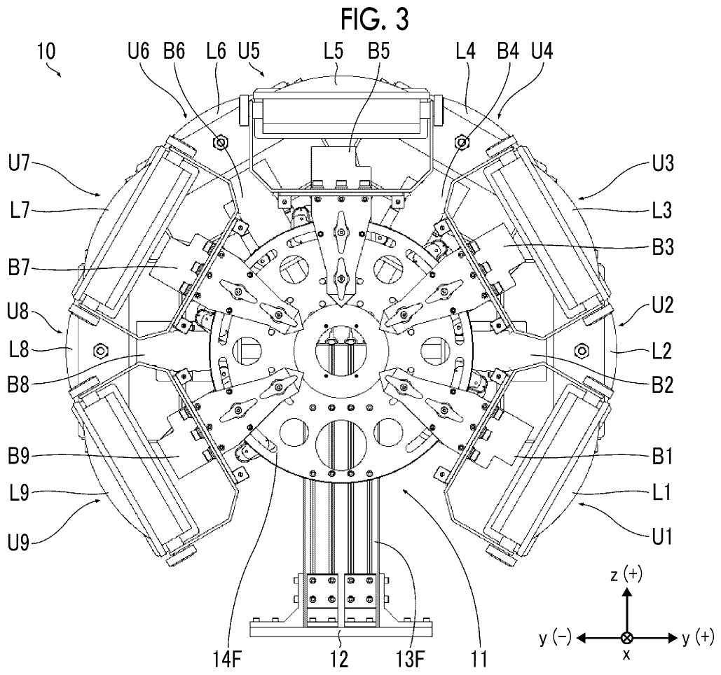

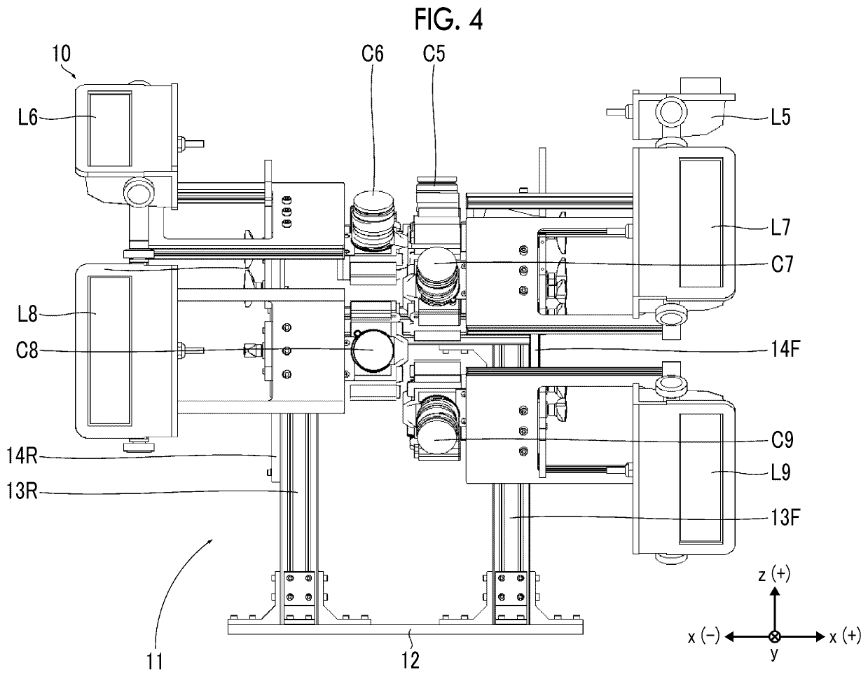

FIG. 2 is a perspective view showing a configuration of the multi-eye imaging apparatus. FIG. 3 is a front view showing the configuration of the multi-eye imaging apparatus. FIG. 4 is a side view showing the configuration of the multi-eye imaging apparatus. In FIGS. 2 to 4, x, y, and z are three axes orthogonal to each other. A plane including an x-axis and a y-axis is defined as a horizontal plane, and a direction of a z-axis is defined as a vertical direction. In addition, a direction of the x-axis is defined as a traveling direction of the carriage Tr, and a + direction of the x-axis (a right direction in FIG. 4) is defined as a progressing direction in a case of imaging. Therefore, the + direction of the x-axis (a right direction in FIG. 4) is a forward direction (advancing direction) of the carriage Tr and the multi-eye imaging apparatus 10, and a − direction (the left direction in FIG. 4) is a rearward direction (retreating direction) of the carriage Tr and the multi-eye imaging apparatus 10.

The multi-eye imaging apparatus 10 is configured with the plurality of cameras and a plurality of illumination devices. The number of cameras and the number of illumination devices are increased or decreased as appropriate according to an imaging target. Herein, a case where the multi-eye imaging apparatus 10 is configured using nine cameras C1 to C9 and nine illumination devices L1 to L9 will be described as an example.

The multi-eye imaging apparatus 10 has a frame 11 for attaching the plurality of cameras C1 to C9 and the plurality of illumination devices L1 to L9.

The frame 11 has a base 12, a front column 13F, a rear column 13R, a front panel 14F, a rear panel 14R, and the like.

The base 12 has a rectangular flat plate shape. The front column 13F and the rear column 13R are installed on the base 12.

The front column 13F and the rear column 13R have a prismatic shape. The front column 13F and the rear column 13R are disposed at a predetermined interval in a front-rear direction (the direction of the x-axis) with respect to the base 12. In addition, the front column 13F and the rear column 13R are disposed perpendicularly with respect to the base 12. A front panel 14F is attached to the front column 13F, and the rear panel 14R is attached to the rear column 13R.

The front panel 14F and the rear panel 14R have a disk-like shape. The front panel 14F and the rear panel 14R are disposed to be orthogonal to the front-rear direction (the direction of the x-axis) of the base 12 and are disposed to be coaxial with each other. An axis that passes through centers of the front panel 14F and the rear panel 14R and that is parallel to the x-axis is defined as an axis of the multi-eye imaging apparatus 10.

The cameras C1 to C9 and the illumination devices L1 to L9 are attached to the front panel 14F or the rear panel 14R via brackets B1 to B9. Hereinafter, as necessary, the camera Cl will be referred to as a “first camera C1”, the camera C2 will be referred to as a “second camera C2”, the camera C3 will be referred to as a “third camera C3”, the camera C4 will be referred to as a “fourth camera C4”, the camera C5 will be referred to as a “fifth camera C5”, the camera C6 will be referred to as a “sixth camera C6”, the camera C7 will be referred to as a “seventh camera C7”, the camera C8 will be referred to as an “eighth camera C8”, and the camera C9 will be referred to as a “ninth camera C9” to distinguish the respective cameras C1 to C9. In addition, the illumination device L1 will be referred to as a “first illumination device L1”, the illumination device L2 will be referred to as a “second illumination device L2”, the illumination device L3 will be referred to as a “third illumination device L3”, the illumination device L4 will be referred to as a “fourth illumination device LA”, the illumination device L5 will be referred to as a “fifth illumination device L5”, the illumination device L6 will be referred to as a “sixth illumination device L6”, the illumination device L7 will be referred to as a “seventh illumination device L7”, the illumination device L8 will be referred to as an “eighth illumination device L8”, and the illumination device L9 will be referred to as a “ninth illumination device L9” to distinguish the respective illumination devices L1 to L9. In addition, the bracket B1 will be referred to as a “first bracket B1”, the bracket B2 will be referred to as a “second bracket B2”, the bracket B3 will be referred to as a “third bracket B3”, the bracket B4 will be referred to as a “fourth bracket B4”, the bracket B5 will be referred to as a “fifth bracket B5”, the bracket B6 will be referred to as a “sixth bracket B6”, the bracket B7 will be referred to as a “seventh bracket B7”, the bracket B8 will be referred to as an “eighth bracket B8”, and the bracket B9 will be referred to as a “ninth bracket B9” to distinguish the respective the brackets B1 to B9.

The first camera C1 and the first illumination device L1 are attached to the front panel 14F via the first bracket B1. The second camera C2 and the second illumination device L2 are attached to the rear panel 14R via the second bracket B2. The third camera C3 and the third illumination device L3 are attached to the front panel 14F via the third bracket B3. The fourth camera C4 and the fourth illumination device L4 are attached to the rear panel 14R via the fourth bracket B4. The fifth camera C5 and the fifth illumination device L5 are attached to the front panel 14F via the fifth bracket B5. The sixth camera C6 and the sixth illumination device L6 are attached to the rear panel 14R via the sixth bracket B6. The seventh camera C7 and the seventh illumination device L7 are attached to the front panel 14F via the seventh bracket B7. The eighth camera C8 and the eighth illumination device L8 are attached to the rear panel 14R via the eighth bracket B8. The ninth camera C9 and the ninth illumination device L9 are attached to the front panel 14F via the ninth bracket B9.

That is, the odd-numbered cameras C1, C3, C5, C7, and C9 and the odd-numbered illumination devices L1, L3, L5, L7, and L9 are attached to the front panel 14F, and the even-numbered cameras C2, C4, C6, C8, and the even-numbered illumination devices L2, L4, L6, L8 are attached to the rear panel 14R.

Sets of the cameras C1 to C9 and the illumination device L1, which are attached to the brackets B1 to B9, individually constitute imaging units U1 to U9, respectively. Hereinafter, as necessary, a set of the first camera Cl and the first illumination device L1 will be referred to as a “first imaging unit U1”, a set of the second camera C2 and the second illumination device L2 will be referred to as a “second imaging unit U2”, a set of the third camera C3 and the third illumination device L3 will be referred to as a “third imaging unit U3”, a set of the fourth camera C4 and the fourth illumination device L4 will be referred to as a “fourth imaging unit U4”, a set of the fifth camera C5 and the fifth illumination device L5 will be referred to as a “fifth imaging unit U5”, a set of the sixth camera C6 and the sixth illumination device L6 will be referred to as a “sixth imaging unit U6”, a set of the seventh camera C7 and the seventh illumination device L7 will be referred to as a “seventh imaging unit U7”, a set of the eighth camera C8 and the eighth illumination device L8 will be referred to as an “eighth imaging unit U8”, and a set of the ninth camera C9 and the ninth illumination device L9 will be referred to as a “ninth imaging unit U9” to distinguish the respective imaging units U1 to U9.

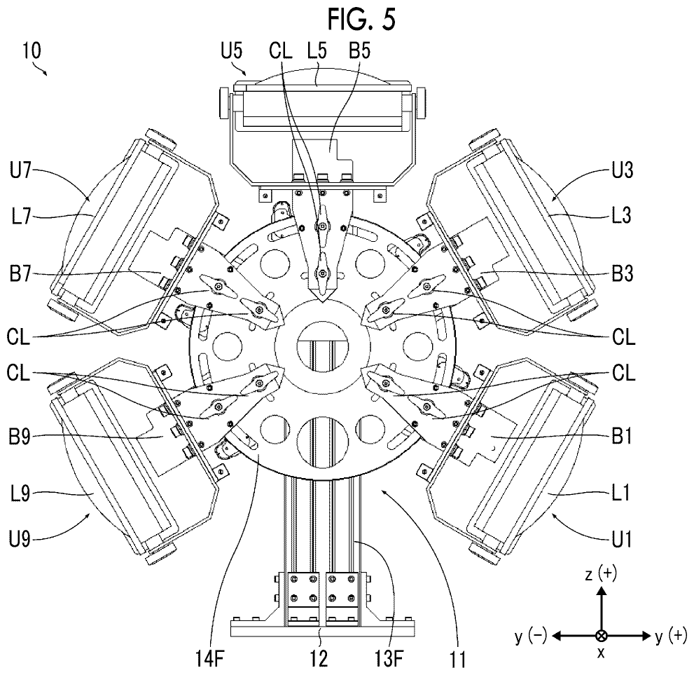

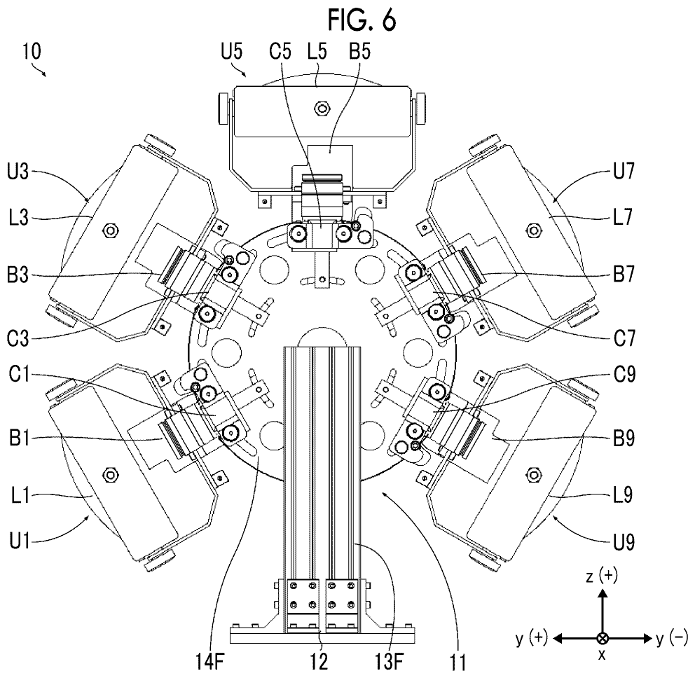

FIG. 5 is a front view showing an attachment state of the cameras and the illumination devices to the front panel. In addition, FIG. 6 is a rear view showing the attachment state of the cameras and the illumination devices to the front panel.

Each of the brackets B1, B3, B5, B7, and B9 is disposed on the same circumference with respect to the front panel 14F. In addition, each of the brackets B1, B3, B5, B7, and B9 is attached to the front panel 14F to be movable in a circumferential direction within a predetermined angular range (for example,) 30°. In addition, each of the brackets B1, B3, B5, B7, and B9 is fixed to the front panel 14F by a clamp (for example, a toggle clamp) CL. Therefore, position adjustment can be easily performed by loosening the clamp CL.

The cameras C1, C3, C5, C7, and C9 are mounted on camera mounting portions comprised in the brackets B1, B3, B5, B7, and B9. In addition, the illumination devices L1, L3, L5, L7, and L9 are mounted on illumination mounting portions comprised in the brackets B1, B3, B5, B7, and B9. The cameras C1, C3, C5, C7, and C9 are attached to the camera mounting portions using, for example, screw holes for a tripod. The illumination devices L1, L3, L5, L7, and L9 are attached to the illumination mounting portions by fixing an arm portion with a bolt.

The cameras C1, C3, C5, C7, and C9 and the illumination devices L1, L3, L5, L7, and L9 attached to the front panel 14F via the brackets B1, B3, B5, B7, and B9 are disposed at the frame 11 in a predetermined posture. Specifically, the cameras C1, C3, C5, C7, and C9 and the illumination devices L1, L3, L5, L7, and L9 are disposed radially outward (normal direction) about the axis of the multi-eye imaging apparatus 10 in a plane (in a zy-plane) orthogonal to the axis of the multi-eye imaging apparatus 10. More specifically, the cameras C1, C3, C5, C7, and C9 are disposed such that imaging optical axes thereof are directed radially outward (normal direction) about the axis of the multi-eye imaging apparatus 10. In addition, bottom surfaces of camera bodies of the cameras C1, C3, C5, C7, and C9 are attached in parallel with the front panel 14F (in parallel with the zy-plane) (a bottom side of an image sensor is attached in parallel with the zy-plane). Accordingly, each of the cameras C1, C3, C5, C7, and C9 is disposed at a predetermined interval in the circumferential direction in the zy-plane about the axis of the multi-eye imaging apparatus 10. The illumination devices L1, L3, L5, L7, and L9 are disposed such that irradiation directions thereof are directed radially outward (normal direction) about the axis of the multi-eye imaging apparatus 10. As a result, the cameras C1, C3, C5, C7, and C9 and the illumination devices L1, L3, L5, L7, and L9 are radially disposed in the zy-plane about the axis of the multi-eye imaging apparatus 10.

Herein, as described above, the brackets B1, B3, B5, B7, and B9 are attached to the front panel 14F to be movable in the circumferential direction within a predetermined angular range. FIGS. 5 and 6 show a state where each of the brackets B1, B3, B5, B7, and B9 is fixed at a reference position. By fixing each of the brackets B1, B3, B5, B7, and B9 at the reference position, the first camera C1 and the first illumination device L1 are disposed at positions of) 330° (−30° in front view (FIG. 5). In addition, the third camera C3 and the third illumination device L3 are disposed at positions of 30°. In addition, the fifth camera C5 and the fifth illumination device L5 are disposed at positions of 90°. In addition, the seventh camera C7 and the seventh illumination device L7 are disposed at positions of 150°. In addition, the ninth camera C9 and the ninth illumination device L9 are disposed at positions of 210°.

Each of the brackets B1, B3, B5, B7, and B9 is attached to be movable in a range of ±15° in the circumferential direction from the reference position. Therefore, a position of each of the cameras C1, C3, C5, C7, and C9 and the illumination devices L1, L3, L5, L7, and L9 can be adjusted in a range of ±15° in the circumferential direction from the reference position.

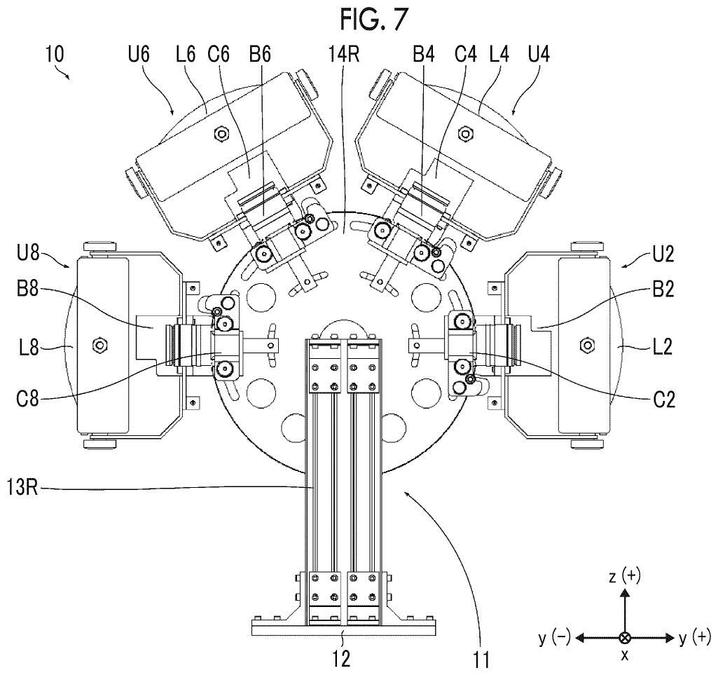

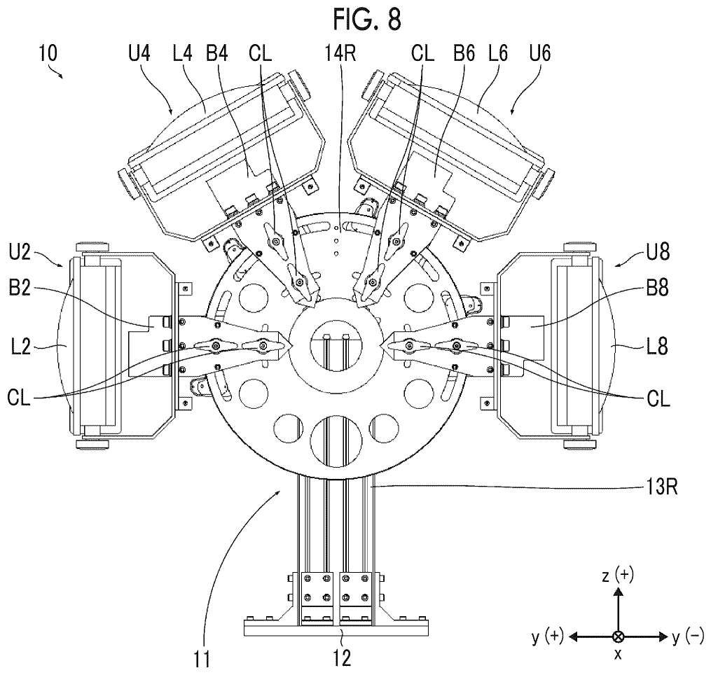

FIG. 7 is a front view showing an attachment state of the cameras and the illumination devices to the rear panel. In addition, FIG. 8 is a rear view showing the attachment state of the cameras and the illumination devices to the rear panel.

Each of the brackets B2, B4, B6, and B8 is disposed on the same circumference with respect to the rear panel 14R. In addition, each of the brackets B2, B4, B6, and B8 is attached to the rear panel 14R to be movable in the circumferential direction within a predetermined angular range (for example,) 30°. In addition, each of the brackets B2, B4, B6, and B8 is fixed to the rear panel 14R by the clamp CL. Therefore, position adjustment can be easily performed by loosening the clamp CL.

The cameras C2, C4, C6, and C8 are mounted on camera mounting portions comprised in the brackets B2, B4, B6, and B8. In addition, the illumination devices L2, L4, L6, and L8 are mounted on illumination mounting portions comprised in the brackets B2, B4, B6, and B8. The cameras C2, C4, C6, and C8 are attached to the camera mounting portions using, for example, screw holes for a tripod. The illumination devices L2, L4, L6, and L8 are attached to the illumination mounting portions by fixing an arm portion with a bolt.

The cameras C2, C4, C6, and C8 and the illumination devices L2, L4, L6, and L8 attached to the rear panel 14R via the brackets B2, B4, B6, and B8 are disposed at the frame 11 in a predetermined posture. Specifically, the cameras C2, C4, C6, and C8 and the illumination devices L2, L4, L6, and L8 are disposed radially outward (normal direction) about the axis of the multi-eye imaging apparatus 10 in a plane (in the zy-plane) orthogonal to the axis of the multi-eye imaging apparatus 10. More specifically, the cameras C2, C4, C6, and C8 are disposed such that imaging optical axes thereof are directed radially outward (normal direction) about the axis of the multi-eye imaging apparatus 10. In addition, bottom surfaces of camera bodies of the cameras C2, C4, C6, and C8 are attached in parallel with the rear panel 14R (in parallel with the zy-plane) (a bottom side of an image sensor is attached in parallel with the zy-plane). Accordingly, each of the cameras C2, C4, C6, and C8 is disposed at a predetermined interval in the circumferential direction in the zy-plane about the axis of the multi-eye imaging apparatus 10. The illumination devices L2, L4, L6, and L8 are disposed such that irradiation directions thereof are directed radially outward (normal direction) about the axis of the multi-eye imaging apparatus 10. As a result, the cameras C2, C4, C6, and C8 and the illumination devices L2, L4, L6, and L8 are radially disposed in the zy-plane about the axis of the multi-eye imaging apparatus 10.

Herein, as described above, the brackets B2, B4, B6, and B8 are attached to the rear panel 14R to be movable in the circumferential direction within a predetermined angular range. FIGS. 7 and 8 show a state where each of the brackets B2, B4, B6, and B8 is fixed at a reference position. By fixing each of the brackets B2, B4, B6, and B8 at the reference position, the second camera C2 and the second illumination device L2 are disposed at positions of 0° in front view (FIG. 7). In addition, the fourth camera C4 and the fourth illumination device L4 are disposed at positions of 60°. In addition, the sixth camera C6 and the sixth illumination device L6 are disposed at positions of 120°. In addition, the eighth camera C8 and the eighth illumination device L8 are disposed at positions of 180°. Therefore, the second camera C2 is disposed between the first camera C1 and the third camera C3 in the circumferential direction. In addition, the fourth camera C4 is disposed between the third camera C3 and the fifth camera C5 in the circumferential direction. In addition, the sixth camera C6 is disposed between the fifth camera C5 and the seventh camera C7 in the circumferential direction. In addition, the eighth camera C8 is disposed between the seventh camera C7 and the ninth camera C9 in the circumferential direction. Similarly, the second illumination device L2 is disposed between the first illumination device L1 and the third illumination device L3 in the circumferential direction. In addition, the fourth illumination device LA is disposed between the third illumination device L3 and the fifth illumination device L5 in the circumferential direction. In addition, the sixth illumination device L6 is disposed between the fifth illumination device L5 and the seventh illumination device L7 in the circumferential direction. In addition, the eighth illumination device L8 is disposed between the seventh illumination device L7 and the ninth illumination device L9 in the circumferential direction.

Each of the brackets B2, B4, B6, and B8 is attached to be movable in a range of ±15° in the circumferential direction from the reference position. Therefore, a position of each of the cameras C2, C4, C6, and C8 and the illumination devices L2, L4, L6, and L8 can be adjusted in a range of ±15° in the circumferential direction from the reference position.

In the multi-eye imaging apparatus 10 configured as described above, the nine cameras C1 to C9 and the nine illumination devices L1 to L9 are disposed at predetermined intervals on an arc about on the axis of the apparatus. Cameras adjacent to each other constitute a pair of cameras having an overlapping imaging region.

Herein, the tunnel structure TS which is an imaging target has an arc cross-sectional shape (semicircular shape). Therefore, each of the cameras C1 to C9 and the illumination devices L1 to L9 is disposed at predetermined intervals in the circumferential direction in the cross section of the tunnel structure TS.

In a case where the brackets BI to B9 are fixed at the reference positions, each of the cameras C1 to C9 and the illumination devices L1 to L is disposed at an interval of 30°. In addition, each of the cameras C1 to C9 and the illumination devices L1 to L is attached to be positionally adjustable in the circumferential direction in a range of ±15°.

The cameras C1 to C9 to be used are digital cameras. The type of digital camera is not particularly limited. It is sufficient that the digital camera has a function of electrically recording images (still images or motion pictures). For example, a lens-interchangeable digital camera is used. In the present embodiment, the cameras C1 to C9 have a storage (storage medium) and store captured images in the storage. The storage may be a built-in memory or an interchangeable memory card.

The illumination devices L1 to L9 to be used are not particularly limited. For example, a halogen lamp is used. In addition, for example, a light emitting diode (LED) lamp, a xenon lamp, or the like can be used. In the present embodiment, an illumination device having a function of adjusting an irradiation angle (irradiation direction) is used. Each of the illumination devices L1 to L9 is rotated (swivels in the front-rear direction) about an axis orthogonal to the optical axes of the cameras C1 to C9, and the irradiation angle (irradiation direction) is adjusted. The illumination devices L1 to L9 have irradiation ranges that can cover the imaging ranges of the cameras C1 to C9.

### Relay Device

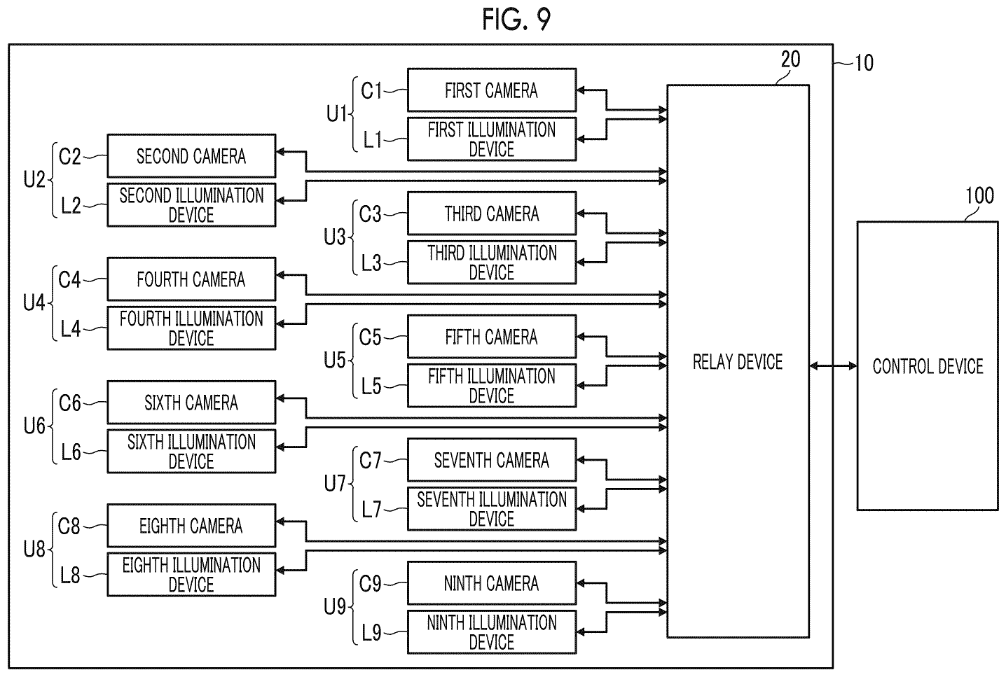

FIG. 9 is a block diagram showing an electric configuration of the multi-eye imaging apparatus.

As shown in FIG. 9, the multi-eye imaging apparatus 10 has a relay device 20 and is connected to the control device 100 via the relay device 20 in a communicable manner.

The relay device 20 is configured with, for example, a computer having a communication function. Each of the cameras C1 to C9 and the illumination devices L1 to L9 is connected to the relay device 20. A connection form between each of the cameras C1 to C9 and the relay device 20 is not particularly limited. The connection may be made in a wired and communicable manner and, or the connection may be made in a wireless and communicable manner.

A communication form between the control device 100 and the relay device 20 is also not particularly limited. The communication may be performed in a wired manner and the communication may be performed in a wireless manner. For example, in the present embodiment, the control device 100 and the relay device 20 are connected through a wireless local area network (LAN).

### Control Device

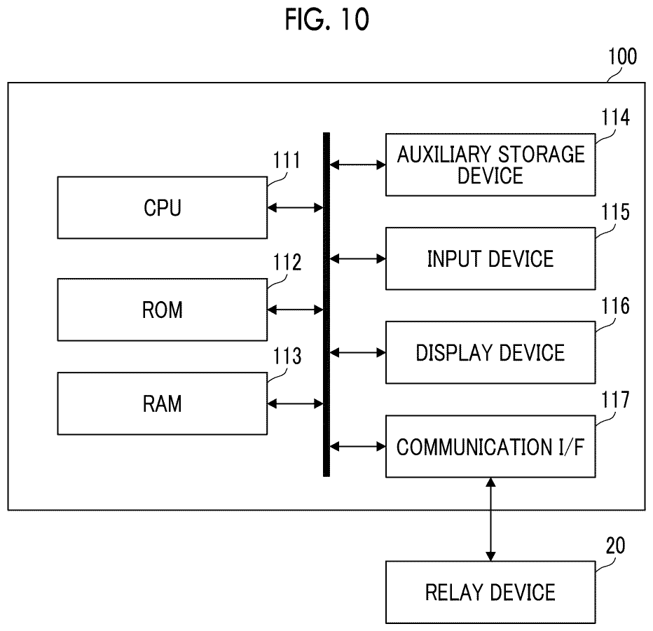

FIG. 10 is a diagram showing an example of a hardware configuration of the control device.

As shown in FIG. 10, the control device 100 comprises a central processing unit (CPU) 111, a read only memory (ROM) 112, a random access memory (RAM) 113, an auxiliary storage device 114, an input device 115, a display device 116, a communication interface (I/F) 117, and the like. In general, this type of configuration can be realized by a computer. For example, in the present embodiment, the control device 100 is configured with a notebook type personal computer. The control device 100 is an example of a processing device.

The control device 100 functions as a control device as the CPU 111, which is a processor, executes a predetermined program. The program executed by the CPU 111 is stored in the ROM 112 or the auxiliary storage device 114.

The auxiliary storage device 114 constitutes a storage unit of the control device 100. The auxiliary storage device 114 is configured with, for example, a hard disk drive (HDD), a solid state drive (SSD), or the like.

The input device 115 constitutes an operation unit of the control device 100. The input device 115 is configured with, for example, a keyboard, a mouse, and a touch panel.

The display device 116 constitutes a display unit of the control device 100. The display device 116 is configured with, for example, a liquid crystal display (LCD), an organic light-emitting diode (OLED) display, or the like.

The communication interface 117 constitutes a communication unit of the control device 100. The communication interface 117 is configured to communicate with at least the relay device 20 through a predetermined communication method. For example, in the present embodiment, the communication interface 117 is configured to communicate through the wireless LAN.

### Functions of Control Device

The control device 100 has a function of controlling the multi-eye imaging apparatus 10 and a function of processing an image captured by the multi-eye imaging apparatus 10. The function of controlling the multi-eye imaging apparatus 10 includes a function of controlling imaging performed by the multi-eye imaging apparatus 10 (imaging control function). The function of processing an image captured by the multi-eye imaging apparatus 10 includes a function of processing a live view image (live view function).

### Imaging Control Function

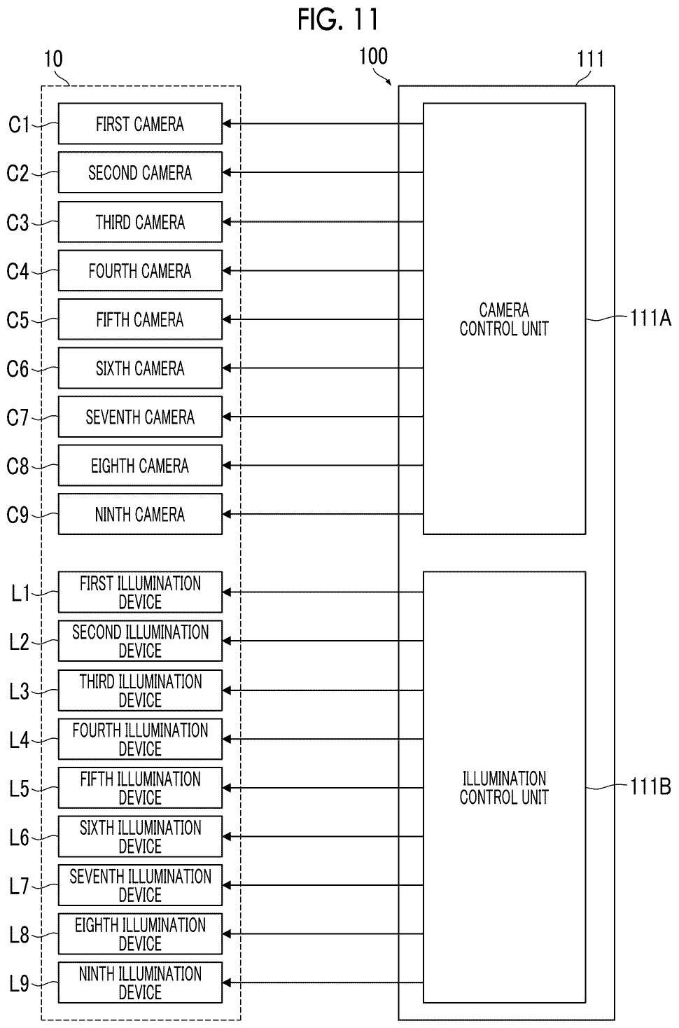

FIG. 11 is a functional block diagram of the imaging control function of the control device.

As shown in FIG. 11, the control device 100 has functions of a camera control unit 111A, an illumination control unit 111B, and the like as imaging control functions. The functions of the camera control unit 111A and the illumination control unit 111B are realized as the CPU 111 executes a predetermined program.

The camera control unit 111A controls the cameras C1 to C9 mounted on the multi-eye imaging apparatus 10 and causes the cameras C1 to C9 to execute imaging. The imaging includes imaging of both a still image and a motion picture. In addition, the imaging of a still image includes so-called interval imaging. The interval imaging is a function of repeatedly executing the imaging of a still image at regular intervals. The camera control unit 111A causes each of the cameras Cl to C9 to execute imaging based on an operation input (an instruction to execute imaging) from the input device 115. In a case of imaging of a motion picture and interval imaging, the imaging is started in response to an instruction to start imaging, and the imaging is ended in response to an instruction to end imaging.

The illumination control unit 111B controls the illumination devices LI to L9 mounted on the multi-eye imaging apparatus 10. That is, on and off of the emission of illumination light from the illumination devices L1 to L9 are controlled. The illumination control unit 111B causes illumination light to be emitted based on an operation input (lighting instruction and extinguishing instruction) from the input device 115.

### Live View Function

The live view is a function of displaying an image captured by the image sensor in real time. The control device 100 displays live view images of the cameras C1 to C9 mounted on the multi-eye imaging apparatus 10 on the display device 116 in a predetermined format.

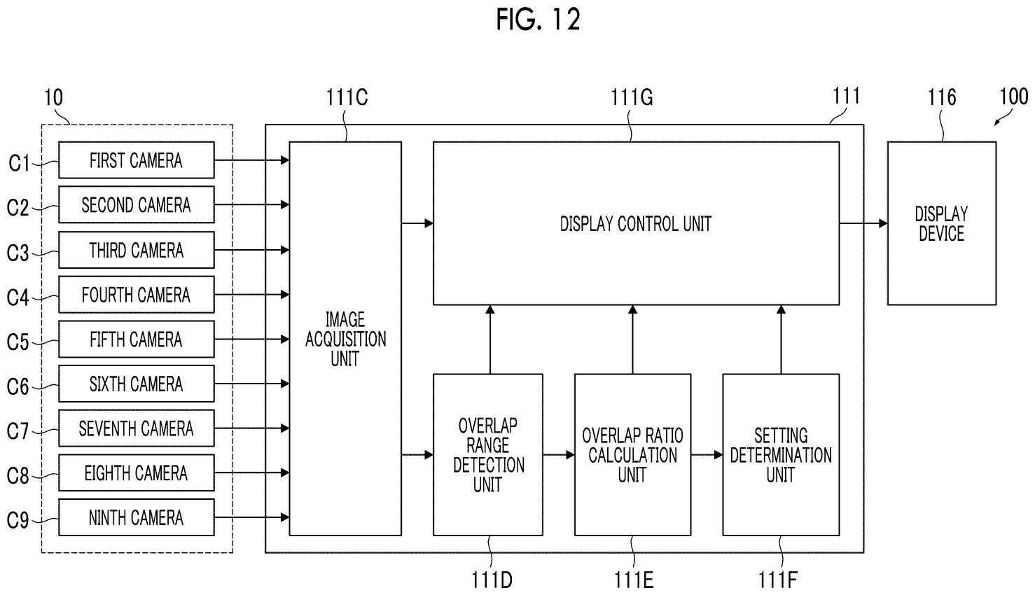

FIG. 12 is a functional block diagram of the live view function of the control device.

As shown in FIG. 12, the control device 100 has, as a live view function, functions of an image acquisition unit 111C, an overlap range detection unit 111D, an overlap ratio calculation unit 111E, a setting determination unit 111F, a display control unit 111G, and the like.

The image acquisition unit 111C acquires live view images of the cameras C1 to C9 mounted on the multi-eye imaging apparatus 10. Each of the cameras C1 to C9 outputs a live view image to the control device 100 under the control of a camera control unit 111A. That is, the images captured by the image sensor are sequentially output in chronological order. The live view images are an example of images captured in chronological order by the cameras.

The overlap range detection unit 111D processes images acquired from the respective cameras C1 to C9 to detect a range in which images overlap between cameras adjacent to each other. Specifically, a range in which the images overlap each other is detected between the first camera C1 and the second camera C2, between the second camera C2 and the third camera C3, between the third camera C3 and the fourth camera C4, between the fourth camera C4 and the fifth camera C5, between the fifth camera C5 and the sixth camera C6, between the sixth camera C6 and the seventh camera C7, between the seventh camera C7 and the eighth camera C8, and between the eighth camera C8 and the ninth camera C9.

A known method is adopted for detecting an overlap range through image processing. For example, the overlap range detection unit 111D detects a feature point of an object in each of two images and detects an overlap range of the two images based on the detected feature point. The detection result is output to the display control unit 111G and the overlap ratio calculation unit 111E.

The overlap ratio calculation unit 111E calculates an image overlap ratio (also referred to as a side-lap ratio) between the cameras C1 to C9 adjacent to each other. The overlap ratio is calculated as a proportion of an overlap of images of cameras adjacent to each other with respect to the entire image. Therefore, for example, in a case where an area of the entire image is defined as Sa and an area of a region where images of cameras adjacent to each other overlap each other in the entire image is defined as Sb, an overlap ratio OLR is calculated through OLR=Sb/Sa.

An overlap ratio between an image of the first camera C1 and an image of the second camera C2 is calculated as an image overlap ratio. In addition, an overlap ratio between the image of the second camera C2 and an image of the third camera C3 is calculated. That is, an overlap ratio between an image of the nth camera and an image of the (n+1)th camera is calculated (n=1, 2, . . . , 8).

The overlap ratio calculation unit 111E calculates an overlap ratio between respective images based on a detection result of the overlap range detection unit 111D. The calculation result is output to the display control unit 111G and the setting determination unit 111F.

The setting determination unit 111F determines whether or not settings of each of the cameras C1 to C9 are appropriate (OK or NG) based on a overlap ratio calculated by the overlap ratio calculation unit 111E. The image captured by each of the cameras C1 to C9 is panoramically composed and is used later. In order to panoramically compose the image captured by each of the cameras C1 to C9 reliably, it is necessary to have a certain overlap ratio between images adjacent to each other or higher. In addition, even in a case where the panoramic composition is not performed, it is necessary to image the entire circumference without omission. The setting determination unit 111F acquires the overlap ratio calculated by the overlap ratio calculation unit 111E, compares the overlap ratio with a threshold value, and determines whether or not the settings of each of the cameras C1 to C9 are appropriate. That is, in a case where the overlap ratio is equal to or higher than the threshold value, it is determined that an image that can be panoramically composed can be imaged with the current settings, and it is determined that the settings are OK. On the other hand, in a case where the overlap ratio is less than the threshold value, it is determined that an image that can be panoramically composed cannot be imaged with the current settings, and it is determined that the settings are NG. For example, in a case where an overlap ratio between an image of the nth camera and an image of the (n+1)th camera is less than the threshold value, it is determined that the settings of the nth camera and the (n+1)th camera are NG. For example, the threshold value is 20%.

The display control unit 111G controls screen display on the display device 116. In the live view function, display of a live view image of each of the cameras C1 to C9 is controlled based on a detection result of an overlap range and a calculation result of an overlap ratio.

### Display of Live View

A live view image of each of the cameras C1 to C9 is displayed on the screen of the display device 116 in a predetermined display form.

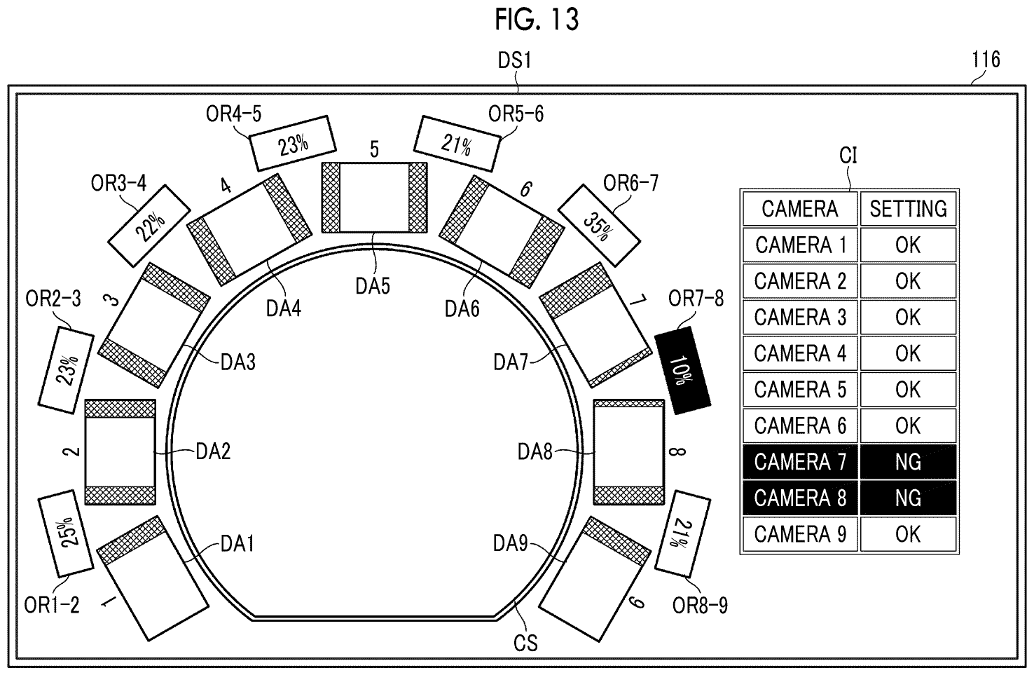

FIG. 13 is a diagram showing an example of a live view display screen.

As shown in the drawing, on a live view display screen DS1, (1) a live view image of each camera, (2) information on an overlap ratio, and (3) information on appropriateness of settings of each camera are displayed. The live view display screen DS1 is an example of a first screen.

### (1) Live View Image of Each Camera

A live view image of each of the cameras C1 to C9 is individually displayed in a plurality of image display regions DA1 to DA9 set in the screen.

Each of the image display regions DA1 to DA9 is independently set in the screen. Herein, the term “independently” means that the respective image display regions DA1 to DA9 do not overlap each other.

In addition, the respective image display regions DA1 to DA9 are disposed in the screen in a layout corresponding to the disposition of the respective cameras C1 to C9 in the multi-eye imaging apparatus 10. The “layout corresponding” herein does not require to be the completely same disposition, but includes a range in which the disposition is recognized to be almost the same. That is, it is sufficient that the disposition is such that an approximate correspondence relationship can be understood. In the multi-eye imaging apparatus 10 of the present embodiment, the respective cameras C1 to C9 are disposed on the same circumference at almost equal intervals (substantially at intervals of) 30°. For this reason, the cameras C1 to C9 are disposed at equal intervals (at intervals of) 30° on the same circumference. In the present embodiment, a cross-sectional view CS of the tunnel structure TS that is an imaging target is displayed in the screen, and the respective image display regions DA1 to DA9 are set around the cross-sectional view CS. Accordingly, an approximate imaging position of each of the cameras C1 to C9 can be ascertained. The cross-sectional view CS is not a precise cross-sectional view of the tunnel structure TS, which is an imaging target, but is an approximate cross-sectional view. That is, the cross-sectional view CS is a view from which an approximate cross-sectional shape is understood.

Hereinafter, as necessary, the image display region DA1 will be referred to as a “first image display region DA1”, the image display region DA2 will be referred to as a “second image display region DA2”, the image display region DA3 will be referred to as a “third image display region DA3”, the image display region DA4 will be referred to as a “fourth image display region DA4”, the image display region DA5 will be referred to as a “fifth image display region DA5”, the image display region DA6 will be referred to as a “sixth image display region DA6”, the image display region DA7 will be referred to as a “seventh image display region DA7”, the image display region DA8 will be referred to as an “eighth image display region DA8”, and the image display region DA9 will be referred to as a “ninth image display region DA9” to distinguish the respective image display regions DA1 to DA9.

An image of the first camera C1 is displayed in the first image display region DA1. It is shown that the number “1” is displayed adjacent to the first image display region DA1, and an image of the first camera C1 is displayed therein. An image of the second camera C2 is displayed in the second image display region DA2. It is shown that the number “2” is displayed adjacent to the second image display region DA2, and an image of the second camera C2 is displayed therein. An image of the third camera C3 is displayed in the third image display region DA3. It is shown that the number “3” is displayed adjacent to the third image display region DA3, and an image of the third camera C3 is displayed therein. An image of the fourth camera C4 is displayed in the fourth image display region DA4. It is shown that the number “4” is displayed adjacent to the fourth image display region DA4, and an image of the fourth camera C4 is displayed therein. An image of the fifth camera C5 is displayed in the fifth image display region DA5. It is shown that the number “5” is displayed adjacent to the fifth image display region DA5, and an image of the fifth camera C5 is displayed therein. An image of the sixth camera C6 is displayed in the sixth image display region DA6. It is shown that the number “6” is displayed adjacent to the sixth image display region DA6, and an image of the sixth camera C6 is displayed therein. An image of the seventh camera C7 is displayed in the seventh image display region DA7. It is shown that the number “7” is displayed adjacent to the seventh image display region DA7, and an image of the seventh camera C7 is displayed therein. An image of the eighth camera C8 is displayed in the eighth image display region DA8. It is shown that the number “8” is displayed adjacent to the eighth image display region DA8, and an image of the eighth camera C8 is displayed therein. An image of the ninth camera C9 is displayed in the ninth image display region DA9. It is shown that the number “9” is displayed adjacent to the ninth image display region DA9, and an image of the ninth camera C9 is displayed therein.

In each of the image display regions DA1 to DA9, an image of each of the cameras C1 to C9 is displayed such that a range in which images overlap each other between images of cameras adjacent to each other is identifiable.

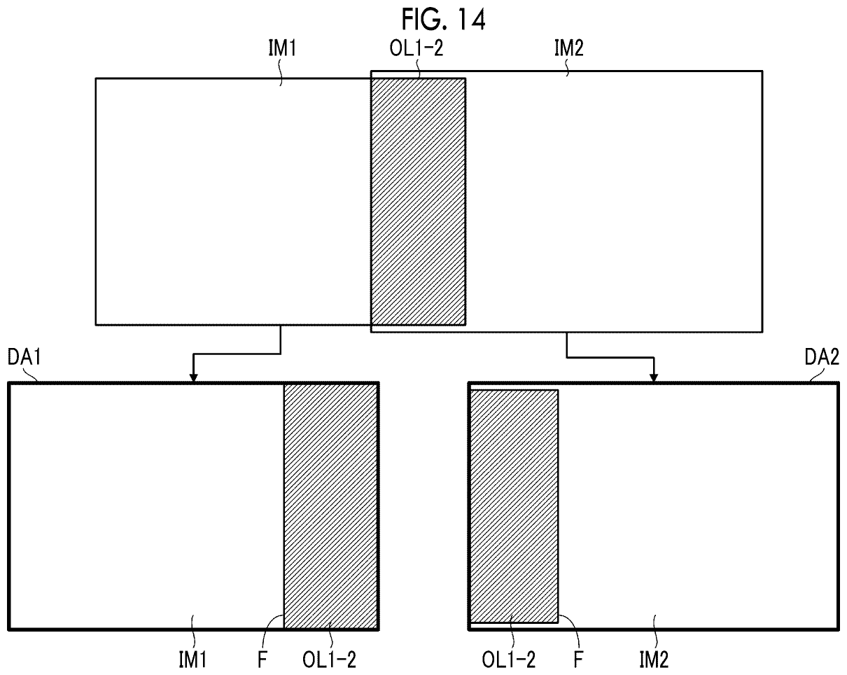

FIG. 14 is a conceptual diagram of display of images in image display regions. FIG. 14 shows an example of a case where an image IM1 captured by the first camera C1 and an image IM2 captured by the second camera C2 are displayed.

The first camera C1 and the second camera C2 constitute a pair of cameras having an overlapping imaging region. In FIG. 14, a region (hatched portion) where the image IM1 and the image IM2 overlap each other is an overlap range OL1-2 of the images.

The image IM1 and the image IM2 are displayed in the first image display region DA1 and the second image display region DA2 such that the overlap range OL1-2 is identifiable. In the example shown in FIG. 14, in each of the image display regions DA1 and DA2, the overlap range OL1-2 is surrounded by a frame F, and brightness of an image in the overlap range OL1-2 is decreased so that the overlap range OL1-2 is displayed in an identifiable manner.

As described above, by displaying an overlap range in an identifiable manner, even in a case where images of the respective cameras C1 to C9 are displayed in the independent image display regions DA1 to DA9, an overlapping state of images between cameras adjacent to each other can be easily ascertained.

In the present example, brightness of an image in an overlap range is changed in addition to the frame F for identification display, but a configuration where only the frame F is displayed may be adopted. Alternatively, a configuration where only the brightness is changed may be adopted. In addition, the overlap range may be masked, and the overlap range may be displayed in an identifiable manner. Various aspects can be adopted for display to be made identifiable.

In addition, only an overlap range between the image IM2 of the second camera C2 and an image of the first camera C1 is shown in the present example, but an overlap range between the image IM2 of the second camera C2 and an image of the third camera C3 is also shown.

As described above, images of the respective cameras C1 to C9 are displayed in the image display regions DA1 to DA9 such that a range in which images overlap each other between images of cameras adjacent to each other can be distinguished. That is, a range in which the images overlap each other (first range) and a range in which the images do not overlap each other (second range) are displayed in an identifiable manner. In FIG. 14, a region indicated by diagonal lines in the image displayed in each of the image display regions is an example of the first range (the range in which the images overlap each other), and a region without the diagonal lines is an example of the second range (the range in which the images do not overlap each other).

### (2) Information on Overlap Ratio

As shown in FIG. 13, information on an overlap ratio is displayed in overlap ratio display regions OR1-2, OR2-3, OR3-4, OR4-5, OR5-6, OR6-7, OR7-8, and OR8-9 set in the screen.

The overlap ratio display regions OR1-2, OR2-3, OR3-4, OR4-5, OR5-6, OR6-7, OR7-8, and OR8-9 are set in rectangular frames and are set between the respective image display regions DAI to DA9. In the present embodiment, since the image display regions DAI to DA9 are disposed in an arc shape at regular intervals, the overlap ratio display regions OR1-2, OR2-3, OR3-4, OR4-5, OR5-6, OR6-7, OR7-8, and OR8-9 are also disposed in an arc shape at regular intervals. In the example shown in FIG. 13, the overlap ratio display regions OR1-2, OR2-3, OR3-4, OR4-5, OR5-6, OR6-7, OR7-8, and OR8-9 are disposed at regular intervals in regions outside the image display regions DA1 and DA2.

The overlap ratio display region OR1-2 is a region where an overlap ratio between an image of the first camera C1 and an image of the second camera C2 is displayed and is set in a region between the first image display region DA1 and the second image display region DA2. The overlap ratio display region OR2-3 is a region where an overlap ratio between the image of the second camera C2 and an image of the third camera C3 is displayed and is set in a region between the second image display region DA2 and the third image display region DA3. The overlap ratio display region OR3-4 is a region where an overlap ratio between the image of the third camera C3 and an image of the fourth camera C4 is displayed and is set in a region between the third image display region DA3 and the fourth image display region DA4. The overlap ratio display region OR4-5 is a region where an overlap ratio between the image of the fourth camera C4 and an image of the fifth camera C5 is displayed and is set in a region between the fourth image display region DA4 and the fifth image display region DA5. The overlap ratio display region OR5-6 is a region where an overlap ratio between the image of the fifth camera C5 and an image of the sixth camera C6 is displayed and is set in a region between the fifth image display region DAS and the sixth image display region DA6. The overlap ratio display region OR6-7 is a region where an overlap ratio between the image of the sixth camera C6 and an image of the seventh camera C7 is displayed and is set in a region between the sixth image display region DA6 and the seventh image display region DA7. The overlap ratio display region OR7-8 is a region where an overlap ratio between the image of the seventh camera C7 and an image of the eighth camera C8 is displayed and is set in a region between the seventh image display region DA7 and the eighth image display region DA8. The overlap ratio display region OR8-9 is a region where an overlap ratio between the image of the eighth camera C8 and an image of the ninth camera C9 is displayed and is set in a region between the eighth image display region DA8 and the ninth image display region DA9.

Information on an overlap ratio between respective images is displayed in the overlap ratio display regions OR1-2, OR2-3, OR3-4, OR4-5, OR5-6, OR6-7, OR7-8, and OR8-9 configured with frames. In addition, the overlap ratio less than the threshold value is displayed in an emphasized manner. For example, a background color and a text color are inverted and displayed. FIG. 13 shows an example in a case where an overlap ratio between an image of the seventh camera C7 and an image of the eighth camera C8 is less than the threshold value. In addition, FIG. 13 shows an example of a case where the image of the seventh camera C7 and the image of the eighth camera C8 are displayed with the foreground and background colours inverted. In this manner, by displaying in an emphasized manner, an image of which an overlap ratio is less than the threshold value can be ascertained at a glance.

A method of displaying in an emphasized manner is not limited to reversing, and other methods can also be adopted. For example, emphasis can be performed by changing a color of a text, changing a color of a frame, turning on and off of display, or displaying a predetermined mark in the vicinity of the frame.

### (3) Information on Appropriateness of Settings of Each Camera

As shown in FIG. 13, information on appropriateness of settings of each camera is displayed in a camera information display region CI set in the screen. In the camera information display region CI, the information on appropriateness of settings is displayed in a list of pictures.

In the camera information display region CI, information on a determination result of appropriateness of settings of each of the cameras C1 to C9 is split and displayed in a cell for each camera. In addition, the camera of which a determination result is NG is displayed in an emphasized manner. For example, a background color and a text color are inverted and displayed. FIG. 13 shows an example of a case where determination results of the seventh camera C7 and the eighth camera C8 are NG. In addition, FIG. 13 shows an example of a case where the image of the seventh camera C7 and the image of the eighth camera C8 are displayed with the foreground and background colours inverted. In this manner, by displaying in an emphasized manner, a camera of which settings are NG can be ascertained at a glance.

### Operation of Imaging System

Imaging of the tunnel structure TS using the imaging system 1 of the present embodiment is performed as follows.

First, the multi-eye imaging apparatus 10 is mounted on the carriage Tr and is positioned at an imaging start position of the tunnel structure TS. Next, the multi-eye imaging apparatus 10 and the control device 100 are connected to each other in a communicable manner. Accordingly, the control device 100 can control the multi-eye imaging apparatus 10.

First, a user instructs the control device 100 to display a live view image. In response to this instruction, the control device 100 instructs each of the cameras C1 to C9 of the multi-eye imaging apparatus 10 to output a live view image. Each of the cameras C1 to C9 outputs the live view image to the control device 100 in response to the instruction.

The control device 100 acquires a live view image from each of the cameras Cl to C9 and causes the display device 116 to display the live view image in a predetermined display aspect.

In the live view display screen DS1, as shown in FIG. 13, in addition to a live view image of each of the cameras C1 to C9, information on an overlap ratio between images of cameras adjacent to each other and information on appropriateness of settings of each of the cameras C1 to C9 are displayed. The live view image of each of the cameras C1 to C9 is displayed such that a range in which images overlap each other between images of cameras adjacent to each other is identifiable.

The user checks appropriateness of settings of the cameras C1 to C9 by viewing the live view display screen DS1. In the example of FIG. 13, it can be seen that the settings of the seventh camera C7 and the eighth camera C8 are NG. The user performs necessary adjustment based on the checked result. In the case of the example of FIG. 13, since an image overlap ratio (35%) between the sixth camera C6 and the seventh camera C7 is larger than an image overlap ratio (10%) between the seventh camera C7 and the eighth camera C8, it can be checked that there is an error in the settings of the seventh camera C7 (a deviation to a sixth camera C6 side). Therefore, in this case, the position of the seventh camera C7 is adjusted. Specifically, the position of the seventh camera C7 is finely adjusted to a position close to the eighth camera C8.

In a case where positions of the cameras C1 to C9 are adjusted during display of live view, each display of the display screen DS1 is also switched. That is, the adjustment result is reflected. The user checks the live view display screen DS1 and adjusts the positions of the cameras C1 to C9 such that determination results of settings of all the cameras C1 to C9 are OK. That is, the positions are adjusted such that an image overlap ratio between cameras adjacent to each other is equal to or larger than the threshold value.

After the adjustment is complete, imaging is started. That is, the inner wall surface of the tunnel structure TS is imaged by the multi-eye imaging apparatus 10 while the carriage Tr is made to travel and is moved in the tunnel structure TS. In a case of imaging a motion picture, the multi-eye imaging apparatus 10 is instructed to start imaging, and the imaging starts. In a case where a still image is manually captured, the user instructs the multi-eye imaging apparatus 10 to perform imaging via the control device 100. In a case of performing interval imaging, imaging start is instructed by designating an imaging interval.

As described above, with the imaging system of the present embodiment, imaging states and setting states of the cameras C1 to C9 mounted on the multi-eye imaging apparatus 10 can be easily checked from the live view display screen DS1. Accordingly, whether or not imaging conditions are correct can be easily checked. In addition, even in a case where adjustment is necessary, the adjustment can be easily performed based on the screen display. Accordingly, work onsite can be significantly reduced.

### Modification Example

### Method of Detecting Overlap Range

A configuration where an overlap range is detected through image processing is adopted in the embodiment, but a method of detecting the overlap range is not limited thereto. In a case where necessary information can be acquired for a subject and a camera, the overlap range can be acquired by calculation from the information. For example, in a case where information on the angle of view of each of the cameras C1 to C9 and information on a distance from each of the cameras C1 to C9 to a tunnel inner wall surface (information on a subject distance) can be acquired, an imaging range of each of the cameras C1 to C9 can be acquired. Further, in a case where information on a positional relationship between the respective cameras C1 to C9 and information on an imaging direction can be acquired, a range in which imaging regions between cameras adjacent to each other overlap each other can be calculated (estimated) from these pieces of information.

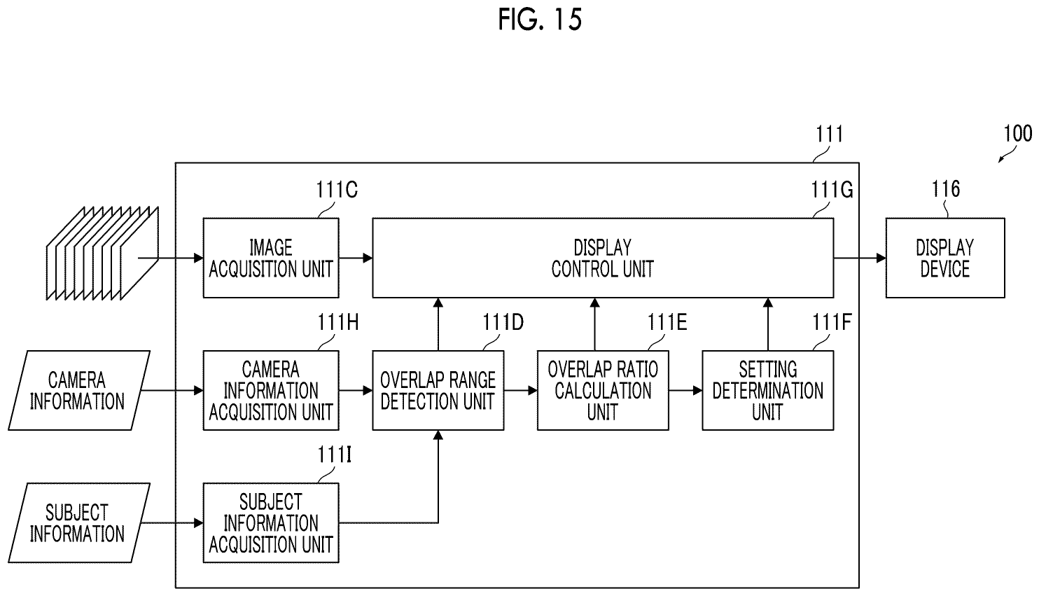

FIG. 15 is a functional block diagram of functions of the control device in a case where an overlap range is acquired by calculation.

As shown in FIG. 15, the control device 100 has functions of a camera information acquisition unit 111H that acquires information related to the cameras C1 to C9 and a subject information acquisition unit 111I that acquires information related to the subject. Functions of each unit are realized by executing a predetermined program via the CPU 111.

The camera information acquisition unit 111H acquires information necessary for calculating an overlap range from each of the cameras C1 to C9. This information includes at least information on the angle of view of each of the cameras C1 to C9. The angle of view can be acquired from information on a focal length and information on a sensor size. Therefore, instead of directly acquiring the information on the angle of view, the information on a focal length and the information on a sensor size can also be acquired. It is assumed that the control device 100 holds, in advance, information on a positional relationship between respective cameras and information on an imaging direction as known information. For example, the information on a positional relationship between the respective cameras in a case where each of the brackets B1 to B9 is positioned at the reference position and the information on an imaging direction are held.

The subject information acquisition unit 111I acquires information on a distance from each of the cameras C1 to C9 to the tunnel inner wall surface (information on a subject distance). In a case where each of the cameras C1 to C9 has a distance measurement function, this information is acquired from each of the cameras C1 to C9. In addition, for example, in a case where the multi-eye imaging apparatus 10 comprises a distance-measuring sensor or distance measurement means such as light detection and ranging or laser imaging detection and ranging (LIDAR), the distance-measuring sensor or the distance measurement unit can also be used. In addition, in a case where design data (for example, computer aided design (CAD) data) of the subject is present, the design data can also be acquired. In a case where the design data of the subject can be acquired, the subject distance can be acquired beforehand from a position where the multi-eye imaging apparatus 10 is installed. For example, a configuration where the design data is acquired through a network can also be adopted.

The overlap range detection unit 111D calculates an imaging region (imaging range) of each of the cameras C1 to C9 and calculates a range in which imaging ranges of cameras adjacent to each other overlap each other, based on information acquired by the camera information acquisition unit 111H and the subject information acquisition unit 111I.

A configuration where in a case where information related to a camera to be used is known, the control device 100 holds the information in advance may be adopted. In this case, only the information related to the subject is acquired from the outside.

In addition, a configuration where a non-overlapping range (second range) is detected instead of an overlapping range (first range) may be adopted. In addition, a configuration where both are detected may be adopted.

### Live View Display Screen

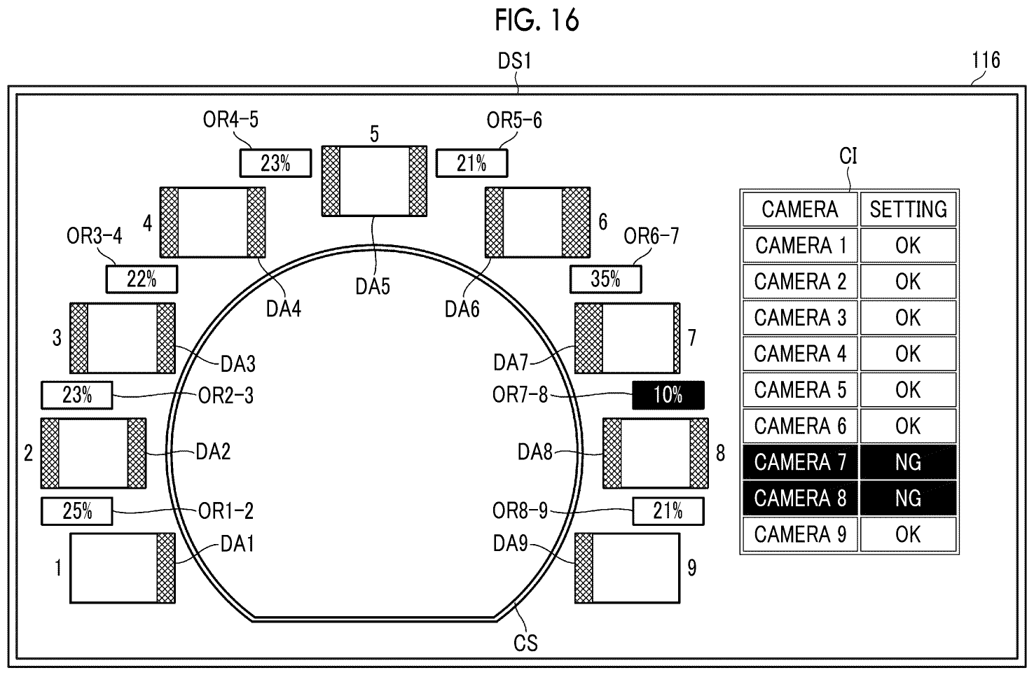

FIG. 16 is a diagram showing another example of the live view display screen.

FIG. 16 is an example of a case where an image of each of the cameras is displayed without inclination. In this case, each of the image display regions DA1 to DA9 is set without inclination. That is, the bottom side of each of the image display regions DA1 to DA9 configured with rectangular frames is set to be parallel to the bottom side of the screen of the display device 116.

As described above, each of the image display regions DA1 to DA9 need only be able to independently display an image of each camera, and a direction thereof and the like can be set as appropriate in consideration of the visibility of the image and the like.

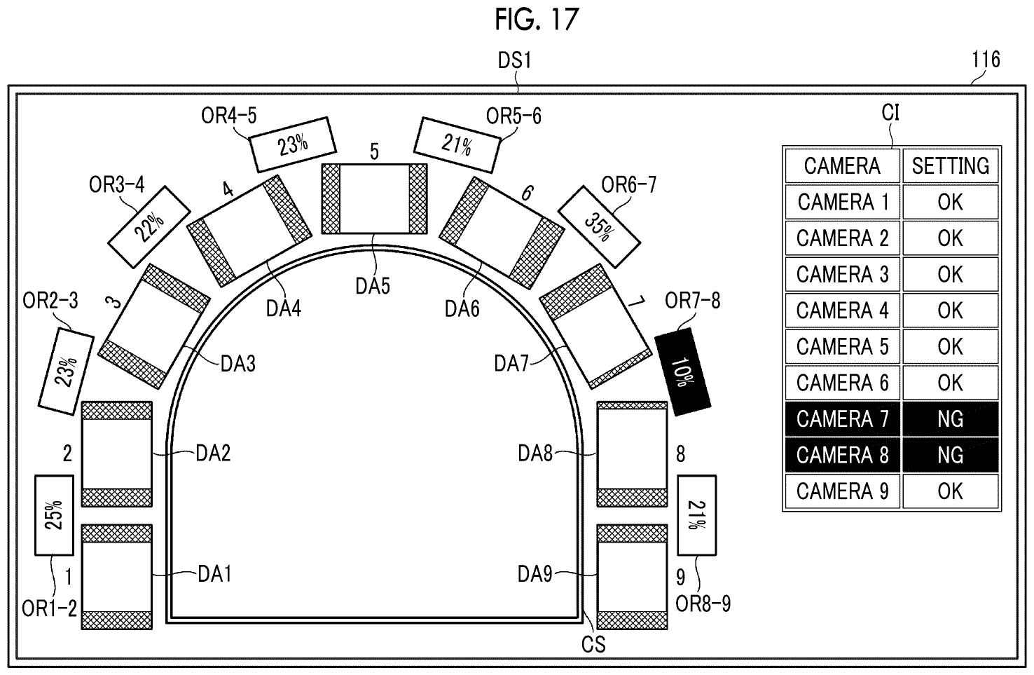

FIG. 17 is a diagram showing still another example of the live view display screen.

FIG. 17 is an example of a case of imaging the tunnel structure having a so-called horseshoe-shaped cross-section. The cross-sectional view CS of the tunnel structure that is an imaging target is displayed in the screen, and the respective image display regions DA1 to DA9 are set around the cross-sectional view CS. Also in this case, each of the image display regions DA1 to DA9 is set in a layout approximately corresponding to the disposition of the cameras C1 to C9.

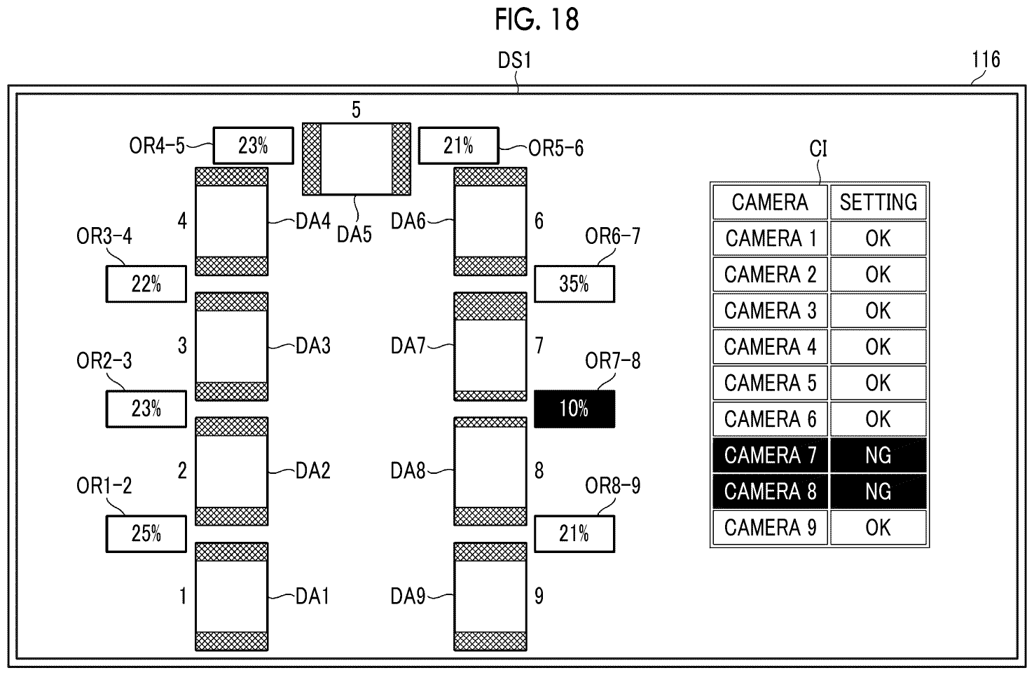

FIG. 18 is a diagram showing still another example of the live view display screen.

FIG. 18 is an example of a case where a cross-sectional view of the tunnel structure is not displayed. As shown in the present example, it is not always necessary to display the cross-sectional view of the tunnel structure. In the present example, each of the image display regions DA1 to DA9 is set in a layout approximately corresponding to the disposition of the cameras C1 to C9. That is, the respective image display regions DA1 to DA9 are set at almost regular intervals in the circumferential direction with respect to the cameras C1 to C9 disposed at almost regular intervals in the circumferential direction.

### Other Modification Examples

In the embodiment, a case of displaying a live view image has been described as an example, but a case of displaying a captured image can also be displayed in the same format.

### Second Embodiment

As described above, in a case where there is an error in settings of cameras, it is necessary to review the settings. The imaging system of the present embodiment is an imaging system further having a function of automatically calculating a correction condition in a case where there is an error in the settings of the cameras and presenting the result to the user. Since a basic configuration of the system is the same, only the functions related to the calculation and presentation of the correction condition will be described herein.

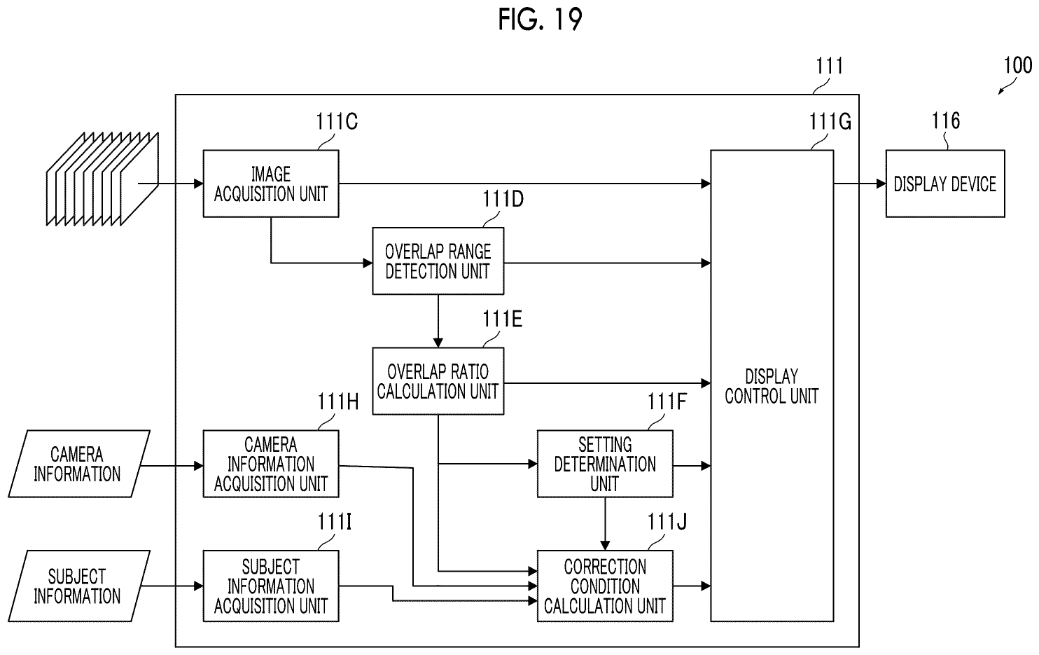

FIG. 19 is a functional block diagram of the control device of the present embodiment.

As shown in FIG. 19, the control device 100 of the present embodiment has functions of the camera information acquisition unit 111H, the subject information acquisition unit 111I, a correction condition calculation unit 111J, and the like regarding the calculation and presentation of the correction condition. Functions of each unit are realized by executing a predetermined program via the CPU 111.

As described above, the camera information acquisition unit 111H acquires information necessary for calculating an overlap range from each of the cameras C1 to C9. In addition, the subject information acquisition unit 111I acquires information on a distance from each of the cameras C1 to C9 to the tunnel inner wall surface (information on a subject distance).

The correction condition calculation unit 111J calculates a correction condition in a case where there is a camera of which settings are NG. That is, the correction condition for imaging with a specified overlap ratio (for example, 20% or more) is calculated. The correction condition calculation unit 111J calculates a necessary correction condition based on information on an overlap ratio calculated by the overlap ratio calculation unit 111E, information acquired by the camera information acquisition unit 111H, and information acquired by the subject information acquisition unit 111I. Specifically, an adjustment direction and an adjustment amount are calculated. As the adjustment direction, a counterclockwise direction is designated as a positive direction and a clockwise direction is designated as a negative direction in a case where the multi-eye imaging apparatus 10 is viewed from the front. The adjustment amount is designated in an angle. The calculation result of the correction condition calculation unit 111J is output to the display control unit 111G. The display control unit 111G displays correction information on the live view display screen DS1.

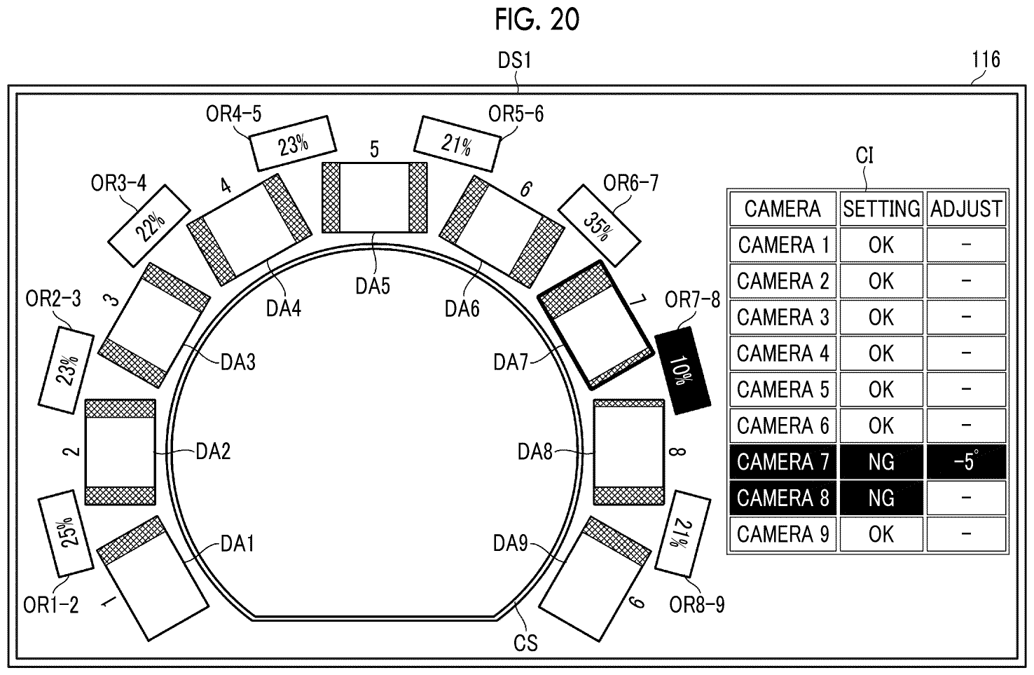

FIG. 20 is a diagram showing another example of the live view display screen.

The display control unit 111G displays correction information in the camera information display region CI together with information on appropriateness of settings of each camera.

In addition, the display control unit 111G displays an image display region of a camera which is an adjustment target in an emphasized manner. FIG. 20 shows an example of a case where the seventh camera C7 is the adjustment target. A method of displaying in an emphasized manner is not particularly limited. For example, the image display region can be emphasized by changing a thickness of the frame, changing the color, or turning on and off. FIG. 20 shows an example of a case where the frame of the image display region is thickened and emphasized.

The user performs necessary adjustment while viewing the live view display screen DS1. In the example of FIG. 20, the seventh camera C7 is inclined by 5° in the clockwise direction (negative direction).

As described above, with the imaging system of the present embodiment, in a case where there is an error in settings of a camera, a necessary adjustment amount is automatically calculated and presented. Accordingly, work onsite can be easily performed.

### Modification Example

In the embodiment, a configuration where a correction direction and a correction amount of a camera are calculated as correction conditions is adopted, but a configuration where only the correction direction or only the correction amount is calculated can also be adopted.

In addition, in the embodiment, a configuration where an overlap ratio is corrected by adjusting the direction (imaging direction) of a camera is adopted, but a configuration where the overlap ratio is corrected by adjusting the focal length (zoom magnification) can also be adopted. In this case, for example, a correction value of the focal length is calculated. Alternatively, a correction direction (a telescopic direction or a wide angle direction) of the focal length is calculated.

In addition, a correction condition may be calculated using only camera information and subject information. Alternatively, the correction condition may be calculated using only information on an overlap ratio.

### Third Embodiment

As described above, in a case of imaging with the plurality of cameras, reimaging is necessary in a case where there is an error in settings of even one camera. However, it takes time and effort to check the settings for each camera. The imaging system of the present embodiment is an imaging system further having a function of collectively managing the plurality of cameras. Since the basic configuration of the system is the same, only the function of collectively managing the plurality of cameras will be described herein.

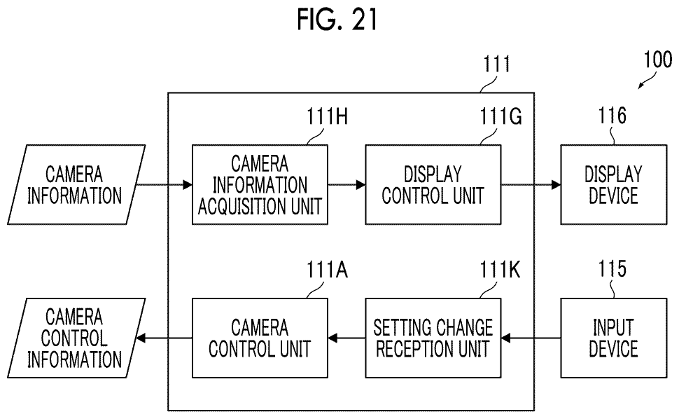

FIG. 21 is a functional block diagram of the control device of the present embodiment.

As shown in FIG. 21, the control device 100 of the present embodiment has functions of the camera information acquisition unit 111H, the display control unit 111G, a setting change reception unit 111K, a camera control unit 111A, and the like with respect to the function of collectively managing the plurality of cameras. Functions of each unit are realized by executing a predetermined program via the CPU 111.

The camera information acquisition unit 111H acquires various types of information from each of the cameras C1 to C9 mounted on the multi-eye imaging apparatus 10. For example, information such as a set shutter speed, an F number, an international organization for standardization (ISO) sensitivity, a focal length, a remaining battery level, and an empty capacity of a storage medium (storage) is acquired. The information, such as the shutter speed, the F number, the ISO sensitivity, and the focal length, is an example of information related to imaging parameters. The remaining battery level information is an example of information related to a battery. The storage medium empty capacity information is an example of information on an available storage capacity.

The display control unit 111G displays information on each of the cameras C1 to C9 (camera information) acquired by the camera information acquisition unit 111H on the screen of the display device 116 in a predetermined display form. This screen is configured to be different from the live view display screen.

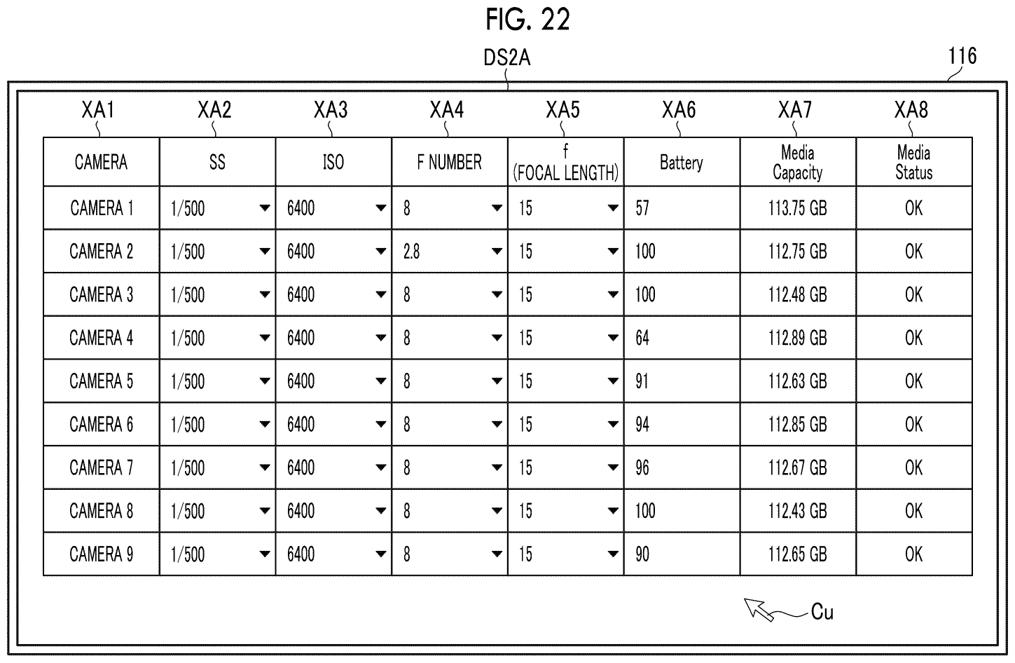

FIG. 22 is a diagram showing an example of a camera information display screen.

As shown in FIG. 22, various types of information acquired from each of the cameras Cl to C9 are displayed in a list of pictures on a camera information display screen DS2A. The camera information display screen DS2A is an example of a second screen.

FIG. 22 shows an example of a case where information such as a shutter speed, an F number, an ISO sensitivity, a focal length, a remaining battery level, and an empty capacity of a storage medium is displayed.

Camera information XA1 is displayed in a first column of a matrix, shutter speed (SS) information XA2 is displayed in a second column, ISO sensitivity information XA4 is displayed in a third column, F number information XA3 is displayed in a fourth column, focal length f information XA5 is displayed in a fifth column, remaining battery level information XA6 is displayed in a sixth column, storage medium empty capacity information XA7 is displayed in a seventh column, and storage medium empty state determination result information XA8 is displayed in an eighth column. The remaining battery level is displayed in a percentage with a fully charged state as 100. In the empty state of the storage medium, a determination result in which an empty capacity equal to or larger than a threshold value is OK and an empty capacity less than the threshold value is NG is displayed. The determination result of the empty state of the storage medium is an example of the determination result of appropriateness of a state of a camera.

In this manner, by displaying information on each of the cameras C1 to C9 mounted on the multi-eye imaging apparatus 10 in a list of pictures, setting states of the respective cameras C1 to C9 can be collectively ascertained.

The setting change reception unit 111K receives a change in settings of each of the cameras C1 to C9 from the user. The setting change is received via the camera information display screen DS2A. That is, the change in settings is received for items displayed in a list of pictures on the camera information display screen DS2A (excluding the remaining battery level and the empty capacity of the storage medium).

In the example shown in FIG. 22, a setting change can be performed for a shutter speed, an F number, an ISO sensitivity, and a focal length.

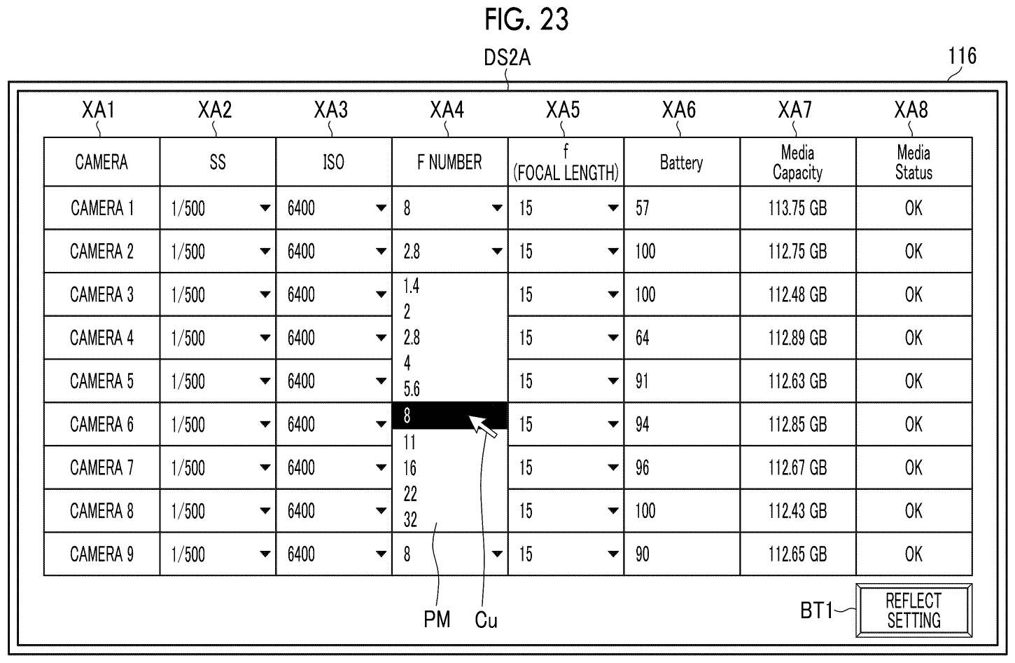

FIG. 23 is a diagram showing an example of a method of receiving a setting change.

As shown in FIG. 23, a pull-down menu (also referred to as a drop-down menu) PM is displayed, and a change in settings is received. The pull-down menu PM is displayed by placing the mouse on an item for which a change in the settings is desired and clicking the item. Selectable items are displayed in a list of pictures in the pull-down menu PM. FIG. 23 shows an example of a case where an F number of the second camera (CAMERA 2) is changed.

In a case where a setting change is performed, a setting reflection button BT1 is displayed on the screen. In a case where the setting change is reflected, the setting reflection button BT1 is clicked. Accordingly, the reception of the setting change is complete.

The camera control unit 111A changes settings of the corresponding camera in accordance with content of the setting change received by the setting change reception unit 111K.

As described above, with the imaging system of the present embodiment, setting states of the cameras C1 to C9 mounted on the multi-eye imaging apparatus 10 can be collectively checked in the control device 100. Accordingly, settings of the respective cameras C1 to C9 can be easily managed. In addition, the settings of each of the cameras C1 to C9 can be changed on a control device 100 side as necessary. Accordingly, the time and effort for setting can be reduced.

### Modification Example

In the embodiment, a configuration where a change in settings of each camera is individually received is adopted, but the change may be collectively made. For example, in a case where a title of each item is clicked, the pull-down menu is displayed, and the selected settings are reflected in all the cameras. Alternatively, a configuration where in a case where settings of one camera are changed, settings of the other cameras are also automatically switched to the same settings may be adopted. In this case, it is preferable that the user can select a case of individually changing the settings and a case of collectively changing the settings. For example, a configuration where a predetermined check box is provided, and the settings are collectively changed only in a case where the check box is checked can be adopted.

In addition, a configuration where a change in settings is reflected in response to an execution instruction by the setting reflection button BT1 is adopted in the embodiment, but a configuration where the change is immediately reflected in the camera may be adopted.

In addition, a configuration where settings are changed with the pull-down menu is adopted in the embodiment, but for example, a configuration where the settings are changed by inputting a numerical value can also be adopted.

### Fourth Embodiment

The imaging system of the present embodiment is an imaging system further having a function of presenting settings of a camera suitable for the subject to the user. Since the basic configuration of the system is the same, only the function of presenting settings of a camera suitable for the subject will be described herein.

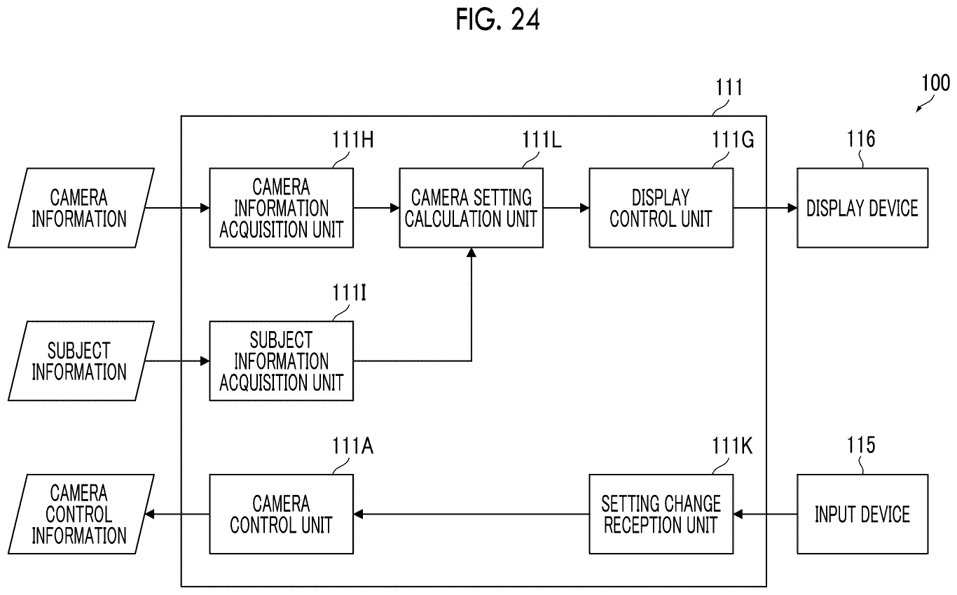

FIG. 24 is a functional block diagram of the control device of the present embodiment.

As shown in FIG. 24, the control device 100 of the present embodiment has functions of the camera information acquisition unit 111H, the subject information acquisition unit 111I, a camera setting calculation unit 111L, the display control unit 111G, the setting change reception unit 111K, the camera control unit 111A, and the like with respect to the function of presenting settings of a camera suitable for the subject. Functions of each unit are realized by executing a predetermined program via the CPU 111.

The camera information acquisition unit 111H acquires information necessary for calculating settings of a camera from each of the cameras C1 to C9. This information includes at least information on the angle of view of each of the cameras C1 to C9 or information with which the angle of view can be calculated (information on a focal length and information on a sensor size). It is assumed that the control device 100 holds, in advance, information on a positional relationship between respective cameras and information on an imaging direction as known information.

The subject information acquisition unit 111I acquires information related to the subject. The information related to the subject includes information with which at least information on a subject distance (information on a distance from each of the cameras C1 to C9 to the tunnel inner wall surface) can be calculated. The subject information acquisition unit 111I acquires design data of the subject, for example.

The camera setting calculation unit 111L calculates (estimates) recommended settings of a camera suitable for imaging the subject based on information acquired by the camera information acquisition unit 111H and the subject information acquisition unit 111I. Specifically, imaging parameters suitable for imaging the subject and installation positions of the respective cameras are calculated. Examples of the imaging parameters to be calculated include information such as a shutter speed, an F number, an ISO sensitivity, and a focal length. Settings of the shutter speed, the F number, and the ISO sensitivity are calculated, for example, based on information on a subject distance, information on brightness of the illumination devices L1 to L9, and the like. Settings of the focal length in which a wall surface can be imaged at a specified resolution are calculated. It is assumed that the control device 100 holds the information on brightness of the illumination devices L1 to L9 in advance as known information. For example, as the installation position of each camera, the adjustment direction and the adjustment amount of the bracket from the reference position are calculated. The installation position of each camera is set such that an image overlap ratio between cameras adjacent to each other satisfies a predetermined condition (for example, 20%).

The display control unit 111G displays information on recommended settings calculated by the camera setting calculation unit 111L (estimation result) on the screen of the display device 116 in a predetermined display form.

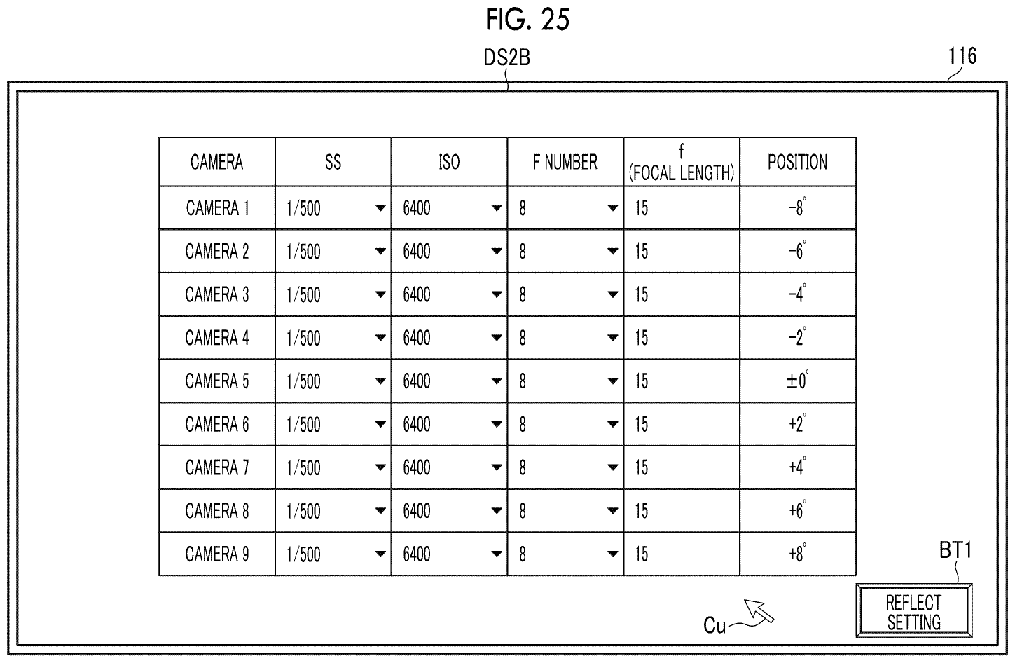

FIG. 25 is a diagram showing an example of a camera recommended settings display screen.

As shown in FIG. 25, information on estimated recommended settings of each camera is displayed on a camera recommended settings display screen DS2B.

FIG. 25 shows an example of a case where recommended settings of a shutter speed, an F number, an ISO sensitivity, and a focal length are displayed as imaging parameters. As shown in FIG. 25, information on recommended settings of the shutter speed, the F number, the ISO sensitivity, and the focal length is displayed for each camera. In addition, information on recommended settings of an installation position (information on the adjustment direction and the adjustment amount of the bracket from the reference position) is displayed for each camera.

In a case where the user accepts recommended settings for an imaging parameter, the user clicks the setting reflection button BT1 displayed on the screen. Accordingly, the reflection of the settings is received. In a case where the settings are reflected, the camera control unit 111A sets imaging parameters of each camera under conditions of the recommended settings.

In a case where the settings are changed, the settings are the same as in the case of the third embodiment. The user places the mouse on an item for which a change in the settings is desired and clicking the item. Accordingly, the pull-down menu is displayed, and recommended settings can be changed (see FIG. 23).

In a case where correction of a camera position is necessary, the user corrects the position of each of the cameras C1 to C9 based on the display of the screen.

As described above, with the imaging system of the present embodiment, settings of a camera suitable for the subject (recommended settings) can be known only by inputting necessary information to the control device 100. Accordingly, various types of settings can be easily performed.

A configuration where settings are reflected in response to an execution instruction by the setting reflection button BT1 is adopted in the embodiment, but a configuration where the settings are automatically set after the calculation of the settings can also be adopted.

### Fifth Embodiment

The imaging system of the present embodiment is an imaging system further having a function of displaying an image captured by the multi-eye imaging apparatus 10 (captured image). The “captured image” herein is an image that is captured in response to an instruction of main imaging (imaging for the purpose of recording) from the user and that is recorded in the storage (storage medium). That is, the captured image is a recorded image. Since the basic configuration of the system is the same, only the function of displaying the captured image will be described herein.

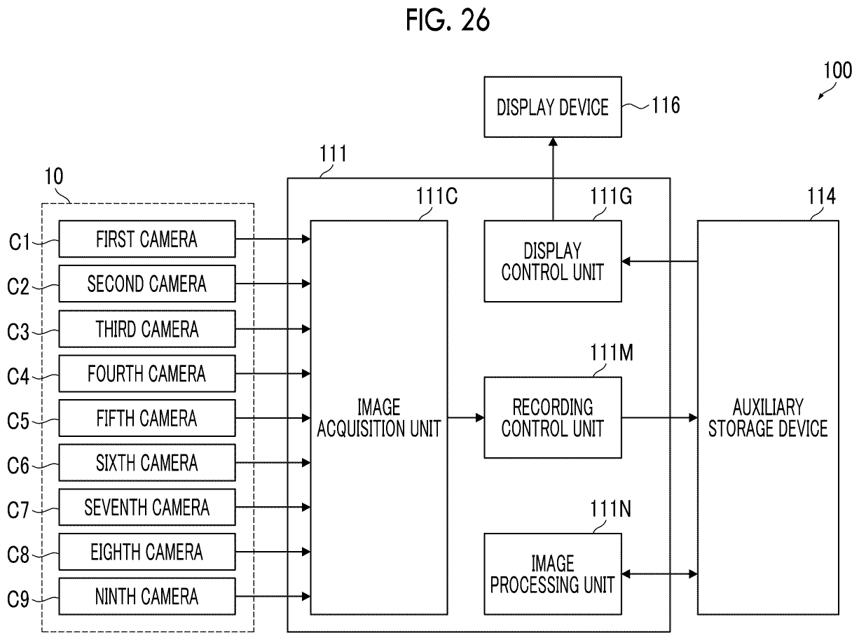

FIG. 26 is a functional block diagram of the control device of the present embodiment.

As shown in FIG. 26, the control device 100 of the present embodiment has functions of the image acquisition unit 111C, a recording control unit 111M, an image processing unit 111N, the display control unit 111G, and the like with respect to the function of displaying a captured image. Functions of each unit are realized by executing a predetermined program via the CPU 111.

The image acquisition unit 111C acquires a captured image from each of the cameras Cl to C9 mounted on the multi-eye imaging apparatus 10. Each of the cameras C1 to C9 captures an image in response to an instruction of main imaging from the control device 100 and outputs the captured image recorded in the storage medium to the control device 100.

The recording control unit 111M records captured images acquired from the respective cameras C1 to C9 in the auxiliary storage device 114. The images are recorded with information on a recording source (information on a camera that has performed imaging) and information on recording order (for example, information on a date and time) in an identifiable manner. For example, the images are recorded by dividing a directory in units of one time of imaging (imaging of one tunnel), and the images are further recorded by dividing the directory for each camera in the directory.

The image processing unit 111N performs predetermined image processing on a captured image in response to an instruction from the user. For example, panoramic composition processing is performed.

The display control unit 111G displays a captured image on the screen of the display device 116 in a predetermined display form in response to an instruction from the user.

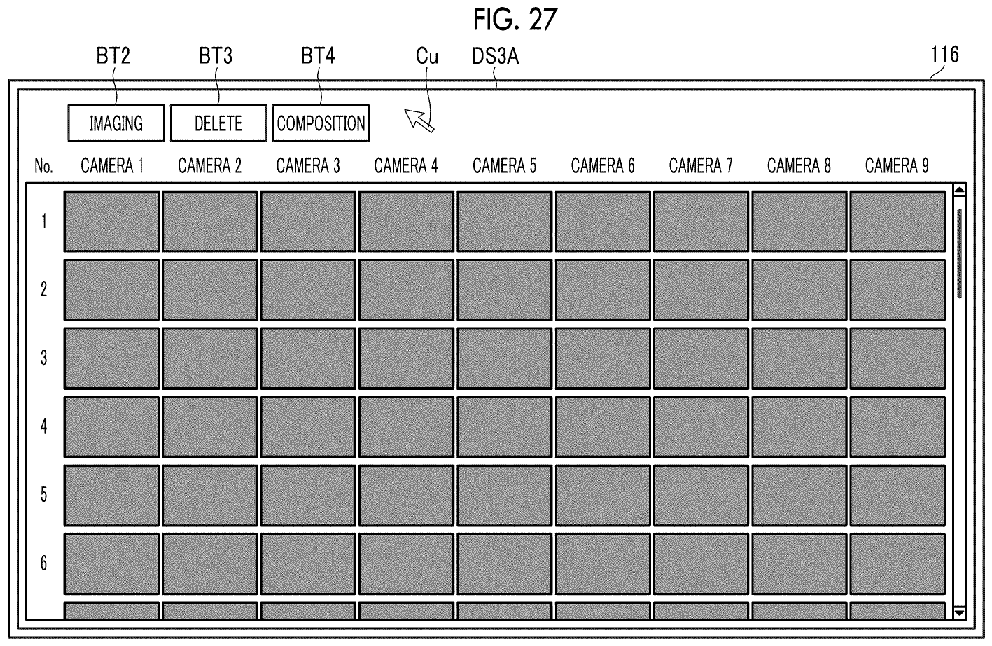

FIG. 27 is a diagram showing an example of a captured image display screen.

As shown in FIG. 27, images captured by the respective cameras C1 to C9 are displayed in chronological order on a captured image display screen DS3A. Images in each column are images captured in chronological order by each of the cameras C1 to C9 and are displayed in chronological order from top to bottom. In addition, images of each row are images captured at the same timing by each of the cameras C1 to C9. The captured image display screen DS3A is an example of a third screen.

As shown in FIG. 27, an imaging button BT2, a delete button BT3, and a composition button BT4 are displayed on the captured image display screen DS3A.

The imaging button BT2 is a button for instructing the multi-eye imaging apparatus 10 to execute main imaging. By pressing the imaging button BT2, the multi-eye imaging apparatus 10 is instructed to perform main imaging of a still image (imaging of a still image for recording) via the camera control unit 111A (see FIG. 11). Then, in a case where the main imaging is performed, the images captured by the respective cameras C1 to C9 (captured images) are output to the control device 100 and are displayed on the screen.

The delete button BT3 is a button for giving an instruction to delete an image. In a case where an image for which deletion is desired is selected from images displayed on the screen and the delete button BT3 is pressed, the selected image is deleted. The deletion of the image may be performed by both the cameras C1 to C9 and the control device 100 or may be performed only by the control device 100.

The composition button BT4 is a button that issues an instruction for panoramic composition. In a case where the composition button BT4 is pressed, images of the respective cameras C1 to C9, which are captured at the same time, are panoramically composed and are displayed on the screen of the display device 116.

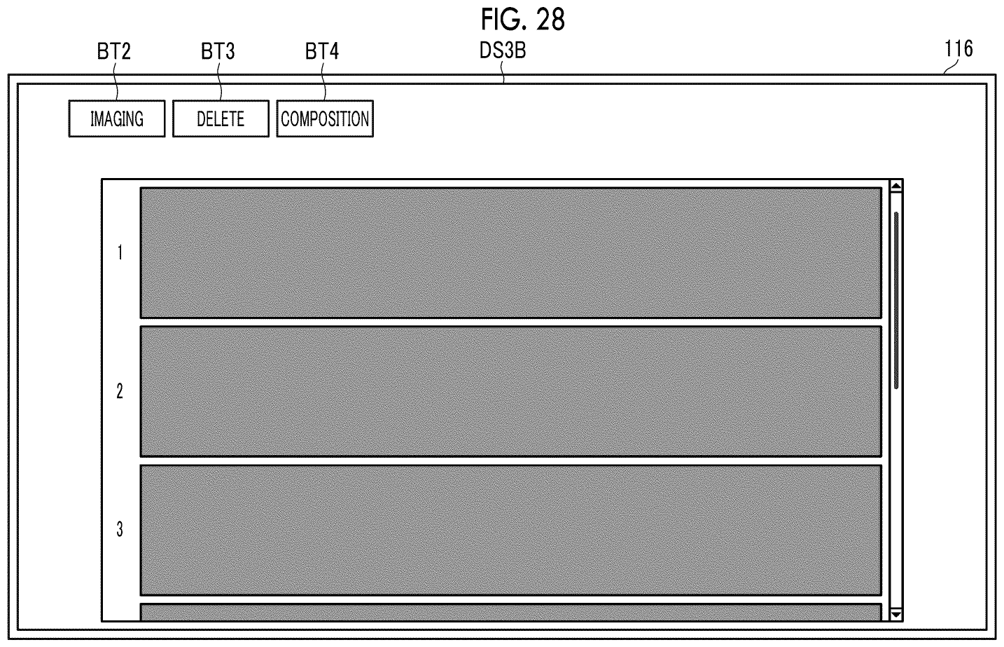

FIG. 28 is a diagram showing an example of a display screen of a panoramically composed image.

As shown in FIG. 28, a panoramically composed image is displayed on a display screen DS3B of the display device 116. Each image is displayed in chronological order from the top to the bottom of the screen. The display screen DS3B is another example of the third screen.

As described above, with the imaging system of the present embodiment, an image captured by the multi-eye imaging apparatus 10 (recorded image) can be checked.

Like a live view image, for a captured image, an overlap range between images adjacent to each other may be displayed in an identifiable manner.

### Modification Example

It is preferable that whether or not a captured image is correctly captured under set conditions (imaging parameters) can be checked. Accordingly, it is preferable to have a configuration where the imaging parameters can be displayed.

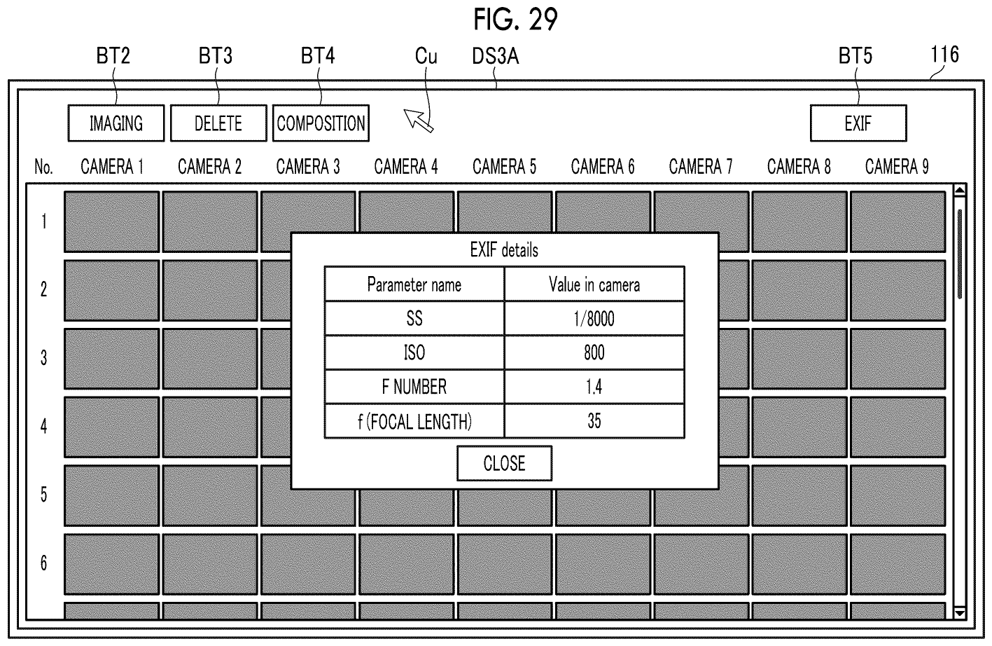

FIG. 29 is a diagram showing an example of display of imaging parameters.

FIG. 29 shows an example of a case where information on a shutter speed, an F number, an ISO sensitivity, and a focal length of a selected image is displayed.

In a case where an image is selected by a cursor Cu, and an EXIF button BT5 on the screen is pressed, information (imaging parameters) on a shutter speed, an F number, an ISO sensitivity, and a focal length of the selected image is displayed on the screen as a pop-up.

In general, an image captured by the digital camera is recorded with various types of information including imaging parameters added as additional information (metadata). For example, an image recorded in an exchangeable image file (EXIF) format is recorded with various types of information added. The display control unit 111G reads out the information added to the image and displays the imaging parameters of the selected image on the screen.

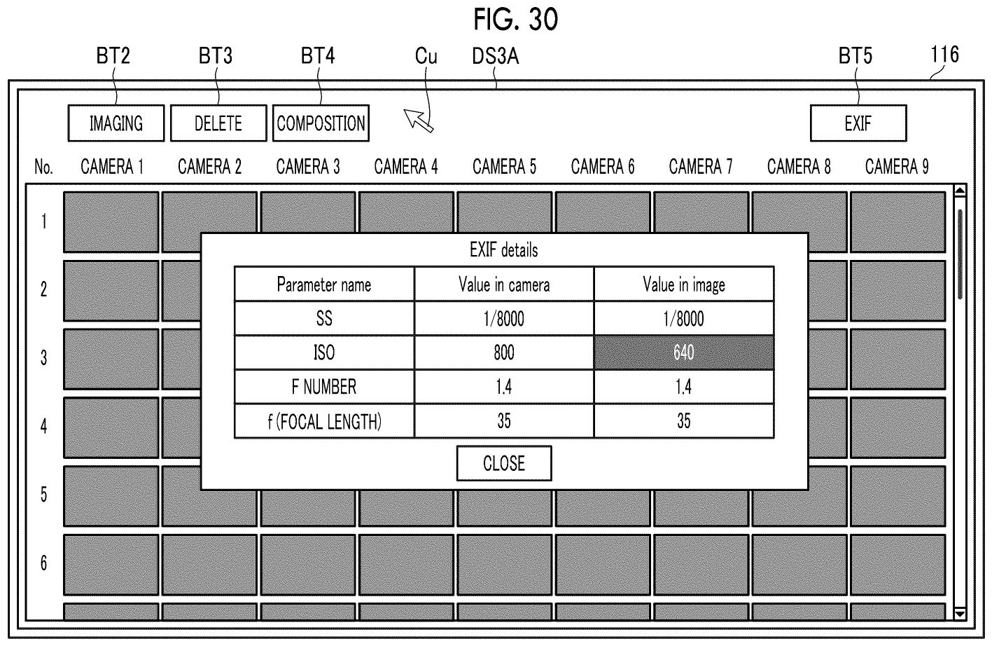

FIG. 30 is a diagram showing another example of the display of imaging parameters.

FIG. 30 is an example of a case where information on imaging parameters set with respect to the cameras (value in camera) and information on imaging parameters of an actually captured image (value in image) are displayed in a comparable manner.

In this manner, by displaying imaging parameters set with respect to the cameras and imaging parameters of an actually captured image in a comparable manner, whether or not the image is correctly captured can be easily checked.

As shown in FIG. 30, in a case where there are different items between imaging parameters set with respect to the cameras and imaging parameters of an actually captured image, it is preferable to display the different items in an emphasized manner. FIG. 30 is an example of a case where the ISO sensitivity is different from the settings, and a text color and a background color are displayed in a inverted and emphasized manner.

In addition, in a case of displaying in a comparable manner as in the present example, it is necessary for the control device 100 to hold information on imaging parameters set in advance with respect to the cameras. In a case where the control device 100 has a function of calculating the imaging parameters (estimation function) (fourth embodiment), the calculated information can be used. In addition, a method in which the user inputs the imaging parameters beforehand or the like can be adopted.

### Sixth Embodiment

The imaging system of the present embodiment is an imaging system further having a function of determining appropriateness of imaging of an image captured by the multi-eye imaging apparatus 10 (captured image). Since the basic configuration of the system is the same, only the function of determining appropriateness of imaging will be described herein.

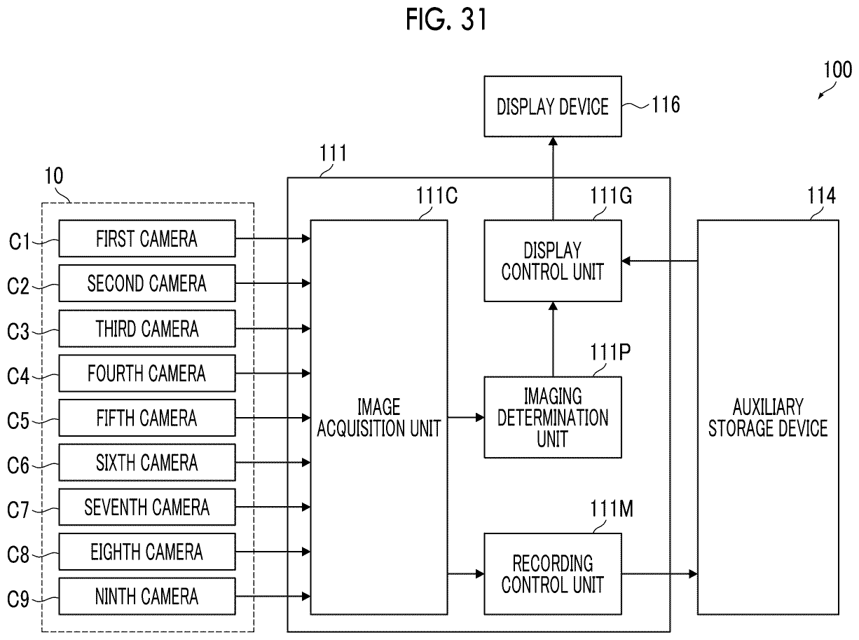

FIG. 31 is a functional block diagram of the control device of the present embodiment.

As shown in FIG. 31, the control device 100 of the present embodiment has functions of the image acquisition unit 111C, an imaging determination unit 111P, the display control unit 111G, and the like with respect to the function of determining appropriateness of imaging. Functions of each unit are realized by executing a predetermined program via the CPU 111.

The image acquisition unit 111C acquires a captured image from each of the cameras C1 to C9 mounted on the multi-eye imaging apparatus 10.

The imaging determination unit 111P analyzes a captured image and determines appropriateness (OK or NG) of imaging. For example, a histogram of the image is analyzed, and whether or not the image is captured with a specified image quality is determined. An image captured with a specified image quality is determined as “OK”, and an image not captured with the specified image quality is determined as “NG”.

The display control unit 111G displays a captured image on the screen of the display device 116 in a predetermined display form together with a determination result.

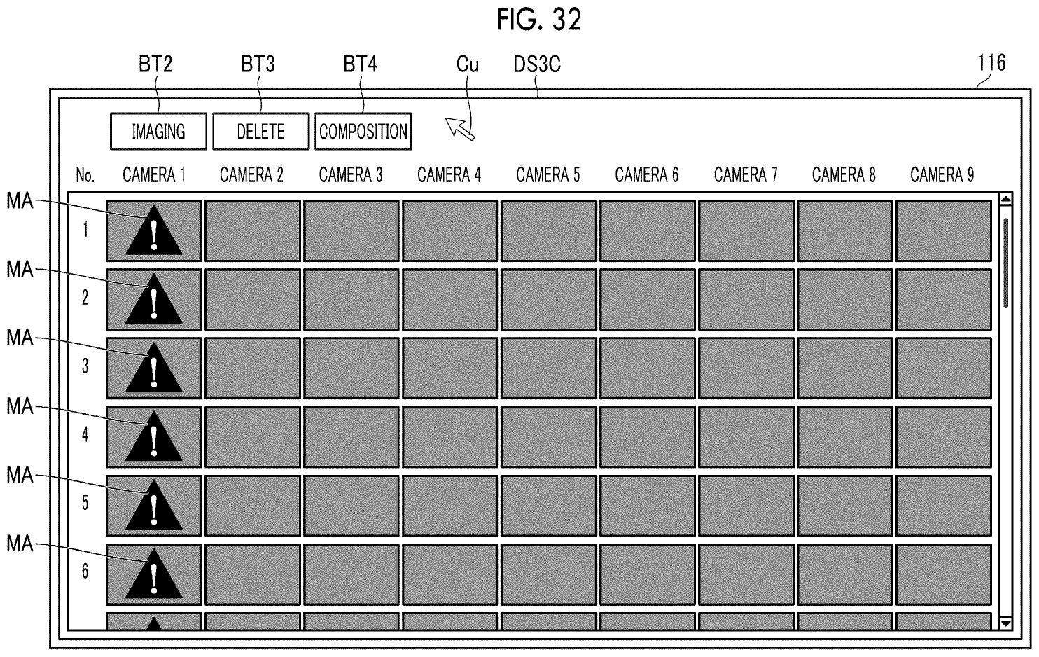

FIG. 32 is a diagram showing an example of the captured image display screen.

As shown in FIG. 32, an image captured by each of the cameras C1 to C9 is displayed in chronological order on the captured image display screen DS3C. In addition, in the determination of appropriateness of imaging, an image determined as NG is marked with a mark MA and displayed. The example shown in FIG. 32 shows an example in which all images captured by the first camera C1 are NG. The captured image display screen DS3C is another example of the third screen.

As described above, with the imaging system of the present embodiment, appropriateness of imaging for each captured image can be easily checked.

### Modification Example

In the embodiment, a configuration where appropriateness of imaging (the quality of an image) is determined based on a histogram of an image is adopted, but a method of determining appropriateness of imaging is not limited thereto. In addition, for example, the appropriateness of imaging can be determined by using a trained model that has learned to determine the quality of the image. In addition, the appropriateness of the imaging may be determined by using information (for example, EXIF information) added to the image. In this case, for example, whether or not the imaging is performed with imaging parameters set in advance is determined, and the appropriateness of the imaging is determined.

### Other Embodiments

### Subject

A case where the tunnel structure TS is imaged has been described as an example in the embodiments, but the subject is not limited thereto. A configuration where the cameras are disposed in a layout corresponding to the subject, and a pair of cameras having overlapping imaging regions is included is adopted.

### System Configuration

The multi-eye imaging apparatus 10 and the control device 100 can also be configured to be connected through the network such as the Internet in a communicable manner.

In addition, functions of the control device can also be realized by a so-called cloud computer. In this case, for example, a terminal (a personal computer, a smartphone, a tablet, or the like) owned by the user can be used as an input device, and a display of the terminal can be used as a display destination.

### Hardware Configuration of Processing Device

Functions of the processing device are realized by various types of processors. The various types of processors include a CPU and/or a graphic processing unit (GPU), which is a general-purpose processor that executes a program to function as the various types of processing sections, a programmable logic device (PLD), which is a processor of which a circuit configuration can be changed after manufacture, such as a field programmable gate array (FPGA), and a dedicated electric circuit, which is a processor having a circuit configuration that is designed for dedicated use in order to perform specific processing, such as an application specific integrated circuit (ASIC). The program is synonymous with software.

One processing section may be configured with one of the various types of processors or may be configured with two or more processors of the same type or different types. For example, one processing section may be configured with a plurality of FPGAs or a combination of a CPU and an FPGA. In addition, one processor may constitute a plurality of processing sections. As an example in which a plurality of processing sections constitute one processor, first, there is a form in which one processor is configured with a combination of one or more CPUs and software as typified by a computer used in a client, a server, or the like, and this processor functions as the plurality of processing sections. Second, there is a form in which a processor that realizes functions of an entire system including the plurality of processing sections with one integrated circuit (IC) chip is used, as typified by a system on chip (SoC) or the like. As described above, the various types of processing sections are configured with one or more of the various types of processors used as a hardware structure.

### EXPLANATION OF REFERENCES

1: imaging system
10: multi-eye imaging apparatus
11: frame
12: base
13F: front column
13R: rear column
14F: front panel
14R: rear panel
20: relay device
100: control device
111: CPU
111A: camera control unit
111B: illumination control unit
111C: image acquisition unit
111D: overlap range detection unit
111E: overlap ratio calculation unit
111F: setting determination unit
111G: display control unit
111H: camera information acquisition unit
111I: subject information acquisition unit
111J: correction condition calculation unit
111K: setting change reception unit
111L: camera setting calculation unit
111M: recording control unit
111N: image processing unit
111P: imaging determination unit
112: ROM
113: RAM
114: auxiliary storage device
115: input device
116: display device
117: communication interface
B1: bracket (first bracket)
B2: bracket (second bracket)
B3: bracket (third bracket)
B4: bracket (fourth bracket)
B5: bracket (fifth bracket)
B6: bracket (sixth bracket)
B7: bracket (seventh bracket)
B8: bracket (eighth bracket)
B9: bracket (ninth bracket)
BT1: setting reflection button
BT2: imaging button
BT3: delete button
BT4: composition button
BT5: EXIF button
C1: camera (first camera)
C2: camera (second camera)
C3: camera (third camera)
C4: camera (fourth camera)
C5: camera (fifth camera)
C6: camera (sixth camera)
C7: camera (seventh camera)
C8: camera (eighth camera)
C9: camera (ninth camera)
CI: camera information display region
CL: clamp
CS: cross-sectional view
Cu: cursor
DA1: image display region (first image display region)
DA2: image display region (second image display region)
DA3: image display region (third image display region)
DA4: image display region (fourth image display region)
DA5: image display region (fifth image display region)
DA6: image display region (sixth image display region)
DA7: image display region (seventh image display region)
DA8: image display region (eighth image display region)
DA9: image display region (ninth image display region)
DS1: live view display screen
DS2A: camera information display screen
DS2B: camera recommended settings display screen
DS3A: captured image display screen
DS3B: panoramically composed captured image display screen
DS3C: captured image display screen
F: frame
IM1: image
IM2: image
L1: first illumination device
L2: second illumination device
L3: third illumination device
LA: fourth illumination device
L5: fifth illumination device
L6: sixth illumination device
L7: seventh illumination device
L8: eighth illumination device
L9: ninth illumination device
MA: mark
OL1-2: overlap range
OR1-2: overlap ratio display region
OR2-3: overlap ratio display region
OR3-4: overlap ratio display region
OR4-5: overlap ratio display region
OR5-6: overlap ratio display region
OR6-7: overlap ratio display region
OR7-8: overlap ratio display region
OR8-9: overlap ratio display region
PM: pull-down menu
Ra: rail
TS: tunnel structure
Tr: carriage
U1: first imaging unit
U2: second imaging unit
U3: third imaging unit
U4: fourth imaging unit
U5: fifth imaging unit
U6: sixth imaging unit
U7: seventh imaging unit
U8: eighth imaging unit
U9: ninth imaging unit
XA1: camera information
XA2: shutter speed information
XA3: F number information
XA4: ISO sensitivity information
XA5: focal length f information
XA6: remaining battery level information
XA7: storage medium empty capacity information
XA8: storage medium empty state determination result information

What is claimed is:

1. A processing device that processes images captured by a plurality of cameras, the processing device comprising a processor,
wherein the processor is configured to:
set a plurality of independent image display regions corresponding to the plurality of cameras on a first screen that outputs to a display destination; and
display, in the plurality of image display regions, images of the plurality of cameras in a state where a first range in which images overlap each other between images of the cameras adjacent to each other and a second range in which the images do not overlap each other are identifiable.

2. The processing device according to claim 1,
wherein the plurality of cameras include a pair of cameras having imaging regions overlapping each other.

3. The processing device according to claim 1,
wherein the processor is configured to set the plurality of image display regions in a layout corresponding to disposition of the plurality of cameras.

4. The processing device according to claim 3,
wherein the processor is configured to detect the first range and/or the second range by processing the images of the plurality of cameras.

5. The processing device according to claim 3,
wherein the processor is configured to acquire information related to a subject and information related to the plurality of cameras and detect the first range and/or the second range based on the acquired information.

6. The processing device according to claim 4,
wherein the processor is configured to:
calculate an overlap ratio of the images displayed in the image display regions based on the first range and/or the second range; and
display the overlap ratio on the first screen.

7. The processing device according to claim 6,
wherein the processor is configured to:
determine appropriateness of settings of the plurality of cameras based on the overlap ratio; and
display a determination result on the first screen.

8. The processing device according to claim 6,
wherein the processor is configured to:
acquire correction conditions of settings of the plurality of cameras based on the overlap ratio; and
display the correction conditions on the first screen.

9. The processing device according to claim 1,
wherein the processor is configured to display the images, which are captured by the plurality of cameras in chronological order, in the image display regions in chronological order.

10. The processing device according to claim 1,
wherein the processor is configured to:
acquire information on the plurality of cameras; and
display the information on the plurality of cameras on a second screen different from the first screen.

11. The processing device according to claim 10,
wherein the processor is configured to:
acquire information related to a subject;
estimate imaging parameters of the plurality of cameras, which are set in a case of imaging the subject, based on the acquired information; and
set the imaging parameters of the plurality of cameras in accordance with an estimation result.

12. The processing device according to claim 10,
wherein the information on the cameras includes at least one type of information related to imaging parameters, information related to an available storage capacity, or information related to a battery.

13. The processing device according to claim 12,
wherein the processor is configured to:
receive individually or collectively a change in the imaging parameters of the plurality of cameras on the second screen; and
change individually or collectively the imaging parameters of the cameras in accordance with received content.

14. The processing device according to claim 12,
wherein the processor is configured to:
determine appropriateness of states of the plurality of cameras based on the information on the plurality of cameras; and
display a determination result on the second screen.

15. The processing device according to claim 1,
wherein the processor is configured to display recorded images of the plurality of cameras on a third screen different from the first screen.

16. The processing device according to claim 15,
wherein the processor is configured to:
panoramically compose the recorded images of the plurality of cameras; and
display a panoramically composed image on the third screen.

17. The processing device according to claim 15,
wherein the processor is configured to:
determine appropriateness of imaging with respect to the recorded images of the plurality of cameras based on the images and/or information added to the images; and
display a determination result on the third screen.

18. The processing device according to claim 17,
wherein the processor is configured to determine the appropriateness of the imaging based on a histogram of the images.

19. The processing device according to claim 17,
wherein the processor is configured to determine the appropriateness of the imaging based on information on imaging parameters added to the images.

20. The processing device according to claim 15,
wherein the processor is configured to:
receive selection of an image on the third screen; and
display an imaging parameter of the selected image on the third screen.

21. The processing device according to claim 20,
wherein the processor is configured to display, on the third screen, the imaging parameter of the selected image and an imaging parameter of the camera in a case of imaging the selected image in a comparable state.
